(19) United States
(12) Patent Application Publication
(10) Pub. No.: US 2018/0063488 A1
(43) Pub. Date: Mar. 1, 2018

(54) INFORMATION PROCESSING APPARATUS, INFORMATION PROCESSING METHOD, AND COMPUTER PROGRAM PRODUCT

(71) Applicant: Kabushiki Kaisha Toshiba, Minato-ku (JP)

(72) Inventors: Masahiro SEKINE, Fuchu (JP); Ryo NAKASHIMA, Kawasaki (JP); Tomohiro NAKAI, Kawasaki (JP); Kaoru SUGITA, Nerima (JP); Norihiro NAKAMURA, Kawasaki (JP); Takaaki KURATATE, Yokohama (JP); Manabu NISHIYAMA, Setagaya (JP)

(73) Assignee: Kabushiki Kaisha Toshiba, Minato-ku (JP)

(21) Appl. No.: 15/440,599

(22) Filed: Feb. 23, 2017

(30) Foreign Application Priority Data
Aug. 24, 2016 (JP) 2016-163859

(51) Int. Cl. H04N 7/18; G06F 17/18

(52) U.S. Cl. CPC H04N 7/185; G06F 17/18

(57) ABSTRACT

According to an embodiment, an information processing apparatus includes a memory and processing circuitry. The processing circuitry configured to acquire a deterioration degree of a structure calculated based on an image including the structure captured by an imaging device. The processing circuitry configured to acquire a measurement time, which is a date and time when the image being a basis of calculation of the deterioration degree has been captured. The processing circuitry configured to calculate necessity of additional measurement of the deterioration degree based on a plurality of the deterioration degrees measured at the measurement times different from each other.

### CROSS-REFERENCE TO RELATED APPLICATIONS

This application is based upon and claims the benefit of priority from Japanese Patent Application No. 2016-163859, filed on Aug. 24, 2016; the entire contents of which are incorporated herein by reference.

### FIELD

Embodiments described herein relate generally to an information processing apparatus, an information processing method, and a computer program product.

### BACKGROUND

To control the quality of structures such as surfaces of roads, railway tracks, or wall surfaces of tunnels, a deterioration degree of the structure is measured. For example, the structure is imaged by a camera mounted on a vehicle or the like, and images acquired by imaging are analyzed to calculate the deterioration degree of the structure. Accordingly, the deterioration degree can be measured comprehensively for the entire large structure and the position at which deterioration has progressed in the structure can be specified.

Because these structures are of a large scale, the range in which the deterioration degree can be measured by using one vehicle is limited. Therefore, it is desired to measure preferentially a position at which progression of deterioration is fast and a position at which an elapsed time since the last measurement of the deterioration degree is long. Further, when a structure is imaged while moving by a vehicle or the like, the measurement accuracy of the deterioration degree may be lower due to factors such as the weather at the time of imaging or the surrounding environment at the time of imaging. Therefore, it is also desired to measure preferentially the deterioration degree of a position at which the measurement accuracy was low at the time of the past measurement.

However, in a conventional deterioration detection system, the necessity of additional measurement of the deterioration degree of structures cannot be calculated accurately. Therefore, in the conventional deterioration detection system, it has been difficult to efficiently measure the deterioration degree in structures.

### BRIEF DESCRIPTION OF THE DRAWINGS

FIG. 1 is diagram illustrating a deterioration management system according to a first embodiment;

FIG. 2 is a diagram illustrating a first processing circuit and a second processing circuit according to the first embodiment;

FIG. 3 is a diagram illustrating a deterioration-degree calculation function;

FIG. 4 is a diagram illustrating a deterioration management function according to the first embodiment;

FIG. 5 is a flowchart illustrating a flow of processing performed by the deterioration management function according to the first embodiment;

FIG. 6 is a first explanatory diagram of a calculation process for calculating necessity;

FIG. 7 is a second explanatory diagram of the calculation process for calculating necessity;

FIG. 8 is a flowchart illustrating a flow of the calculation process for calculating necessity;

FIG. 9 is a diagram illustrating a first function to be used for calculating a specific gravity;

FIG. 10 is a diagram illustrating a second function to be used for calculating variance;

FIG. 11 is a diagram illustrating a first example of a probability distribution;

FIG. 12 is a diagram illustrating a second example of a probability distribution;

FIG. 13 is a diagram illustrating a combined probability distribution;

FIG. 14 is a diagram illustrating a third function to be used for calculating necessity;

FIG. 15 is a diagram illustrating a first example of an aggregate deterioration degree;

FIG. 16 is a diagram illustrating a second example of an aggregate deterioration degree;

FIG. 17 is a diagram illustrating probability distributions when an elapsed time is short and a change amount of a deterioration degree is small;

FIG. 18 is a diagram illustrating probability distributions when a change amount of a deterioration degree is large;

FIG. 19 is a diagram illustrating probability distributions when an elapsed time is long and a change amount of a deterioration degree is small;

FIG. 20 is a diagram illustrating a deterioration management function according to a modification of the first embodiment;

FIG. 21 is a diagram illustrating a first processing circuit and a second processing circuit according to a second embodiment;

FIG. 22 is a diagram illustrating a graph representing reliability with respect to a luminance;

FIG. 23 is a diagram illustrating a graph representing reliability with respect to a resolution;

FIG. 24 is a diagram illustrating a graph representing reliability with respect to a moving speed;

FIG. 25 is a diagram illustrating a graph representing reliability with respect to the amount of obstacles;

FIG. 26 is a diagram illustrating a graph representing reliability with respect to camera performance;

FIG. 27 is a diagram illustrating a deterioration management function according to the second embodiment;

FIG. 28 is a flowchart illustrating a flow of processing performed by the deterioration management function according to the second embodiment;

FIG. 29 is a diagram illustrating a fourth function to be used for calculating variance;

FIG. 30 is a diagram illustrating probability distributions when reliability is high and an elapsed time is short;

FIG. 31 is a diagram illustrating probability distributions when reliability is low and a change amount of a deterioration degree is small;

FIG. 32 is a diagram illustrating a deterioration management function according to a modification of the second embodiment;

FIG. 33 is a diagram illustrating a deterioration management function according to a third embodiment;

FIG. 34 is a flowchart illustrating a flow of processing performed by the deterioration management function according to the third embodiment;

FIG. 35 is a diagram illustrating a first display example of necessity;

FIG. 36 is a diagram illustrating a second display example of necessity; and

FIG. 37 is a diagram illustrating a deterioration management function according to a modification of the third embodiment.

### DETAILED DESCRIPTION

According to an embodiment, an information processing apparatus includes a memory and processing circuitry. The processing circuitry configured to acquire a deterioration degree of a structure calculated based on an image including the structure captured by an imaging device. The processing circuitry configured to acquire a measurement time, which is a date and time when the image being a basis of calculation of the deterioration degree has been captured. The processing circuitry configured to calculate necessity of additional measurement of the deterioration degree based on a plurality of the deterioration degrees measured at the measurement times different from each other.

Embodiments are described below with reference to the accompanying drawings. In the following embodiments, parts denoted by like reference signs have substantially identical configurations and perform substantially identical operations. Therefore, redundant descriptions are appropriately omitted except for different points.

### First Embodiment

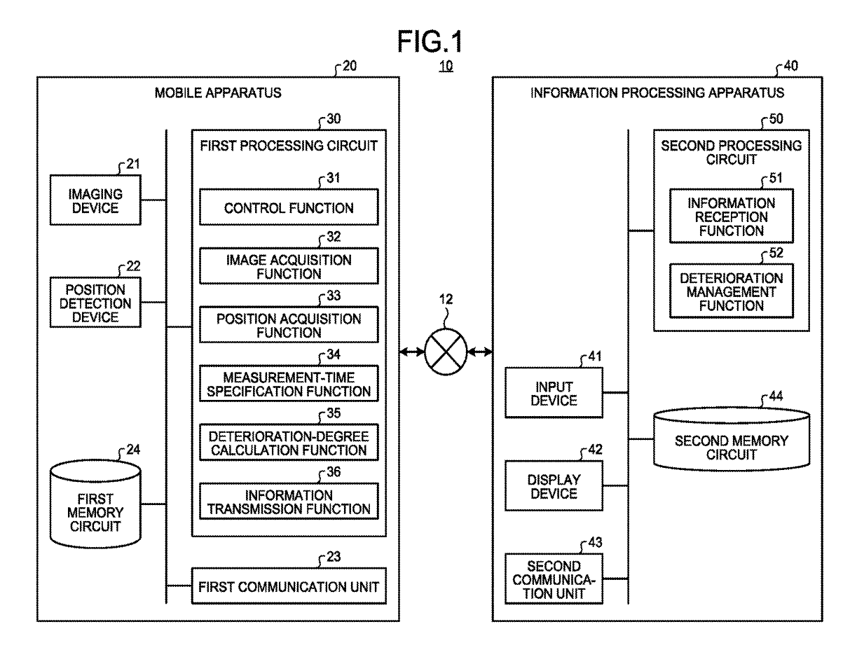

FIG. 1 is a diagram illustrating a deterioration management system 10 according to a first embodiment. The deterioration management system 10 calculates a deterioration degree of a structure. The deterioration management system 10 calculates the necessity of additional measurement of the deterioration degree.

The structure can be surfaces of roads, railway tracks, bridges, buildings, wall surfaces of tunnels, or the like. The structure can be floors, wall surfaces, piping of liquid, gas, or the like in a building.

The deterioration degree is the degree of cracks, flaws, dents, distortion, peeling, taints, or the like, or a combination thereof. The deterioration degree is represented by, for example, multiple values. The deterioration degree can be a numerical value, for example, of from 0.0 to 1.0 inclusive. Alternatively, the deterioration degree can be a numerical value, for example, of from 0 to 100 inclusive. The deterioration degree can be also information indicating a plurality of levels.

A measurement unit of the deterioration degree can be any unit. For example, when the structure is the road, the measurement unit can be an area of 50 cm×50 cm, an area of 100 m×100 m, or a regional unit.

The necessity indicates the necessity level of additional measurement of the deterioration degree. For example, the deterioration degree needs to be measured immediately as a value of the necessity increases. The necessity can be, for example, a numerical value of from 0.0 to 1.0 inclusive. The necessity can be, for example, a numerical value of from 0 to 100 inclusive. The necessity can be a binary value indicating “necessary” or “not necessary”. The necessity is calculated, for example, for each measurement unit of the deterioration degree. Further, the necessity can be calculated for each unit obtained by coordinating a plurality of measurement units of the deterioration degree.

The date and time can be a standard time at a point where the deterioration management system 10 is used, or can be a time calculated from the start of use of the structure.

The deterioration management system 10 includes a mobile apparatus 20 and an information processing apparatus 40. The mobile apparatus 20 and the information processing apparatus 40 can be connected to each other via a network 12.

The mobile apparatus 20 is an information processing device to be mounted on a mobile object such as a vehicle. The mobile object can be a robot, a drone, or the like. The mobile apparatus 20 captures an image of a structure while moving. The mobile apparatus 20 measures a deterioration degree of the structure based on the captured image of the structure. Simultaneously, the mobile apparatus 20 acquires a position in the structure whose deterioration degree has been measured, and a measurement time indicating the date and time when the image, which is a basis of calculation of the deterioration degree, has been captured.

The information processing apparatus 40 is, for example, a dedicated computer or a general-purpose computer. The information processing apparatus 40 can be a personal computer (PC) or a computer included in a server that saves and manages information. The information processing apparatus 40 acquires the deterioration degree, the position, and the measurement time via the network 12. The information processing apparatus 40 calculates the necessity of additional measurement of the deterioration degree with respect to an arbitrary target position in the structure based on the deterioration degrees at a plurality of different measurement times.

The mobile apparatus 20 includes an imaging device 21, a position detection device 22, a first communication unit 23, a first memory circuit 24, and a first processing circuit 30.

The imaging device 21 is mounted on the mobile object. The imaging device 21 captures an image of an external structure from the mobile object. The imaging device 21 provides the captured image to the first processing circuit 30. The image captured by the imaging device 21 can be various images such as a visible light image, an infrared image, and a range image.

The position detection device 22 detects the position in the structure where the imaging device 21 has captured the image. For example, when the structure is a road, the position detection device 22 uses a signal or the like from a global positioning system (GPS) satellite to detect the latitude and the longitude thereof. The position detection device 22 can detect the position in the structure, whose image has been captured by the imaging device 21, by using another method.

The first communication unit 23 is an interface that performs input and output of information with an external device such as the information processing apparatus 40 via the network 12.

The first memory circuit 24 stores therein required data according to a process performed by the first processing circuit 30. The first memory circuit 24 stores therein a program to be executed by the first processing circuit 30.

For example, the first memory circuit 24 is a random access memory (RAM), a semiconductor memory device such as a flash memory, a hard disk, an optical disk, or the like. The process performed by the first memory circuit 24 can be performed by an external memory device of the mobile apparatus 20. The first memory circuit 24 can be a memory medium that stores or temporarily stores therein a program by downloading the program transmitted by a local area network (LAN), the Internet, or the like.

The first processing circuit 30 includes a control function 31, an image acquisition function 32, a position acquisition function 33, a measurement-time specification function 34, a deterioration-degree calculation function 35, and an information transmission function 36. These functions are described later.

The control function 31 is an example of a control unit. The image acquisition function 32 is an example of an image acquisition unit. The position acquisition function 33 is an example of a position acquisition unit. The measurement-time specification function 34 is an example of a measurement-time specification unit. The deterioration-degree calculation function 35 is an example of a deterioration-degree calculation unit. The information transmission function 36 is an example of an information transmission unit.

The first memory circuit 24 stores therein programs for causing the first processing circuit 30 to implement the control function 31, the image acquisition function 32, the position acquisition function 33, the measurement-time specification function 34, the deterioration-degree calculation function 35, and the information transmission function 36. The first processing circuit 30 is a processor that reads the programs from the first memory circuit 24 and executes the programs to implement the functions corresponding to the respective programs. The first processing circuit 30 in a state of having read the respective programs has the respective functions illustrated in the first processing circuit 30 in FIG. 1. The first processing circuit 30 can be configured by a single processor or by a plurality of independent processors. In the first processing circuit 30, a specific function can be implemented by executing a program by a dedicated independent program execution circuit.

The term “processor” means a circuit such as a central processing unit (CPU), a graphical processing unit (GPU), an application specific integrated circuit (ASIC), and a programmable logic device (such as a simple programmable logic device (SPLD), a complex programmable logic device (CPLD), or a field programmable gate array (FPGA)). The processor reads and executes the program saved in a memory circuit to implement the function. The program can be directly incorporated into a circuit of the processor instead of saving the program in the memory circuit. In this case, the processor reads and executes the program incorporated in the circuit to implement the function.

The information processing apparatus 40 includes an input device 41, a display device 42, a second communication unit 43, a second memory circuit 44, and a second processing circuit 50.

The input device 41 receives various instructions and information input from an operator. The input device 41 is, for example, a pointing device such as a mouse or a trackball, or a keyboard.

The display device 42 displays various pieces of information. The display device 42 is, for example, a liquid crystal display.

The second communication unit 43 is an interface that performs input and output of information with an external device such as the mobile apparatus 20 via the network 12.

The second memory circuit 44 stores therein required data according to a process performed by the second processing circuit 50. The second memory circuit 44 stores therein a program to be executed by the second processing circuit 50.

For example, the second memory circuit 44 is a RAM, a semiconductor memory device such as a flash memory, a hard disk, an optical disk, or the like. The process performed by the second memory circuit 44 can be performed by an external memory device of the information processing apparatus 40. The second memory circuit 44 can be a memory medium that stores or temporarily stores therein a program by downloading the program transmitted by a LAN, the Internet, or the like.

The second processing circuit 50 includes an information reception function 51 and a deterioration management function 52. These functions are described later. The information reception function 51 is an example of an information reception unit. The deterioration management function 52 is an example of a deterioration management unit.

The second memory circuit 44 stores therein programs for causing the second processing circuit 50 to implement the information reception function 51 and the deterioration management function 52. The second processing circuit 50 is a processor that reads the programs from the second memory circuit 44 and executes the programs to implement the functions corresponding to the respective programs. The second processing circuit 50 in a state of having read the respective programs has the respective functions illustrated in the second processing circuit 50 in FIG. 1. The second processing circuit 50 can be configured by a single processor or by a plurality of independent processors. In the second processing circuit 50, a specific function can be implemented by executing a program by a dedicated independent program execution circuit.

The mobile apparatus 20 calculates the deterioration degree of a structure based on an image captured by the imaging device 21. Alternatively, the mobile apparatus 20 can calculate the deterioration degree based on information detected by a sensor other than the imaging device 21. For example, the sensor can be an electromagnetic sensor, an ultrasonic sensor, or the like. In this case, the mobile apparatus 20 calculates the deterioration degree of a structure based on an electromagnetic signal or an ultrasonic signal.

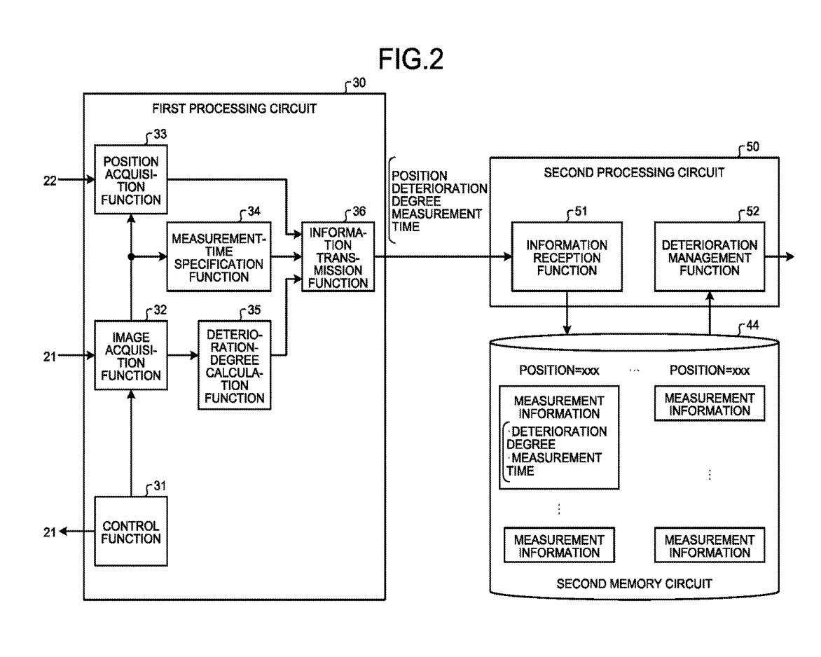

FIG. 2 is a diagram illustrating configurations of the first processing circuit 30 and the second processing circuit 50 according to the first embodiment. The first processing circuit 30 includes the control function 31, the image acquisition function 32, the position acquisition function 33, the measurement-time specification function 34, the deterioration-degree calculation function 35, and the information transmission function 36.

The control function 31 controls an imaging operation performed by the imaging device 21. For example, the control function 31 causes the imaging device 21 to image a structure at a timing at which the mobile apparatus 20 moves to a preset imaging position.

The image acquisition function 32 acquires an image captured by the imaging device 21. The position acquisition function 33 acquires a position in the structure captured by the imaging device 21 from the position detection device 22. The measurement-time specification function 34 specifies a measurement time, which is the date and time when the imaging device 21 has imaged the structure. The deterioration-degree calculation function 35 calculates the deterioration degree of the structure based on the image acquired by the image acquisition function 32.

The information transmission function 36 controls the first communication unit 23 to transmit the position in the structure at which the image being the basis of calculation of the deterioration degree has been captured (that is, the position at which the deterioration degree has been measured), the deterioration degree, and the measurement time when the image being the basis of calculation of the deterioration degree has been captured, to the information processing apparatus 40.

The second processing circuit 50 includes the information reception function 51 and the deterioration management function 52.

The information reception function 51 controls the second communication unit 43 to receive the position, the deterioration degree, and the measurement time from the mobile apparatus 20. The information reception function 51 causes the second memory circuit 44 to store therein the transmitted position, deterioration degree, and measurement time. For example, the information reception function 51 generates measurement information including the corresponding deterioration degree and measurement time, and causes the second memory circuit 44 to store therein the measurement information for each position.

The second memory circuit 44 can store therein the position, the deterioration degree, and the measurement time by any method, so long as, by being specified of the position, the deterioration degree and the measurement time corresponding to the position can be read. For example, the second memory circuit 44 can add a unique ID set for each calculation process of the deterioration degree performed by the deterioration-degree calculation function 35 to each of the position, the deterioration degree, and the measurement time. Accordingly, when the position is specified, the second memory circuit 44 can cause the deterioration degree and the measurement time having the same ID to be read out.

The deterioration management function 52 receives designation of a target position at which the necessity is calculated. The deterioration management function 52 reads deterioration degrees at different measurement times with respect to the designated target position from the second memory circuit 44. The deterioration management function 52 then calculates the necessity of additional measurement of the deterioration degree based on the deterioration degrees at the different measurement times.

The first processing circuit 30 may not include the deterioration-degree calculation function 35, and instead, the second processing circuit 50 of the information processing apparatus 40 can include the deterioration-degree calculation function 35. In this case, the information transmission function 36 of the first processing circuit 30 transmits the image obtained by imaging a structure to the information processing apparatus 40 instead of the deterioration degree. The deterioration-degree calculation function 35 of the information processing apparatus 40 calculates the deterioration degree based on the received image.

A part or all of the functions of the deterioration management function 52 included in the second processing circuit 50 of the information processing apparatus 40 can be provided in the first processing circuit 30 of the mobile apparatus 20. The mobile apparatus 20 and the information processing apparatus 40 can be connected to each other at all times via the network 12, or can be connected to each other when the mobile apparatus 20 accesses the information processing apparatus 40.

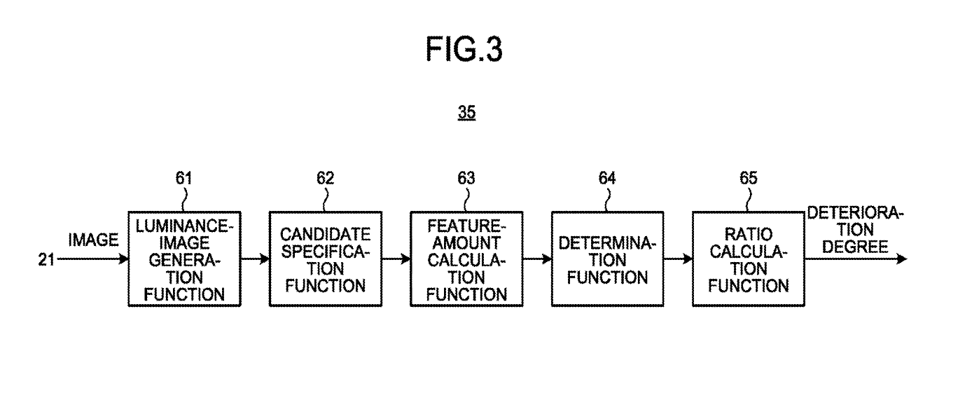

FIG. 3 is a diagram illustrating a configuration of the deterioration-degree calculation function 35. For example, it is assumed here that the structure is a road, and the deterioration degree is a crack rate on the road surface. In this case, for example, as illustrated in FIG. 3, the deterioration-degree calculation function 35 includes a luminance-image generation function 61, a candidate specification function 62, a feature calculation function 63, a determination function 64, and a ratio calculation function 65.

The luminance-image generation function 61 generates a luminance image expressed by luminance components from an image captured by the imaging device 21. The candidate specification function 62 extracts a candidate portion of a trace of crack from the luminance image. On the image, the crack is expressed in the form of a line and has a different luminance from that of the circumference. For example, the candidate specification function 62 differentiates the luminance image to detect pixels whose luminance values indicate a valley or a peak. Subsequently, the candidate specification function 62 couples the detected images. The candidate specification function 62 specifies, as a candidate of a crack, a portion in which the length of the coupled part is within a predetermined range, and a luminance difference from the circumference is equal to or larger than a predetermined value.

The feature calculation function 63 acquires a partial image of the specified candidate of a crack including circumference pixels thereof. The feature calculation function 63 calculates a feature of a predetermined type in the partial image of the specified candidate of a crack.

The determination function 64 determines whether the specified candidate is a crack or not based on the feature of the partial image of the candidate of a crack. For example, the determination function 64 performs the determination by using a determination device that has learnt beforehand, for example, by a supervised learning method.

The ratio calculation function 65 calculates the number of candidates determined as the crack in a preset range. That is, the ratio calculation function 65 calculates a cracking area ratio. The deterioration-degree calculation function 35 outputs the cracking area ratio calculated in this manner as a deterioration degree.

The calculation method of a deterioration degree illustrated in FIG. 3 is an example only, and the deterioration-degree calculation function 35 can calculate the deterioration degree by using another method. The deterioration-degree calculation function 35 can calculate a degree of not only a crack, but also a degree of flaws, dents, distortions, peeling, taints, or the like as a deterioration degree.

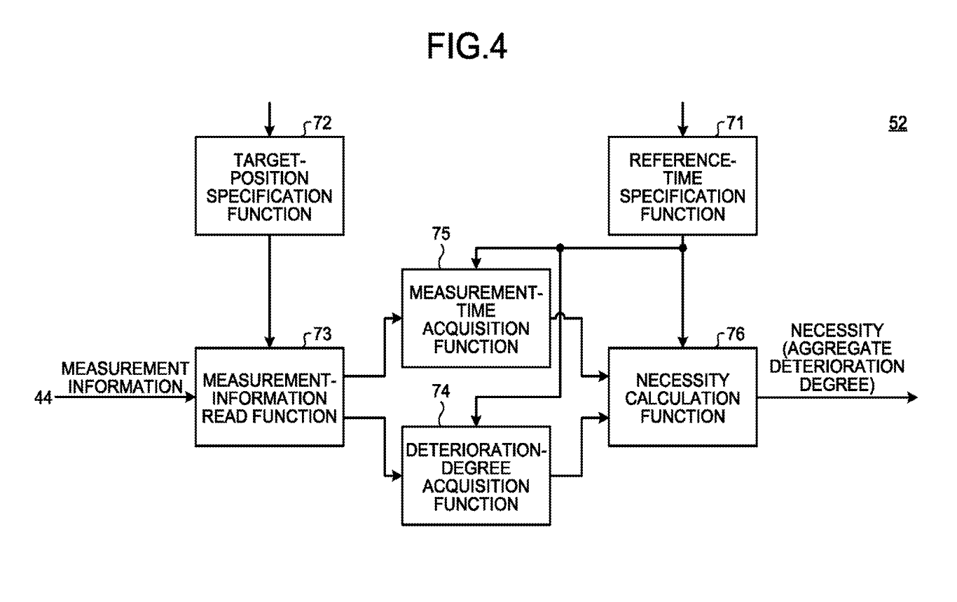

FIG. 4 is a diagram illustrating a configuration of the deterioration management function 52 according to the first embodiment. The deterioration management function 52 includes a reference-time specification function 71, a target-position specification function 72, a measurement-information read function 73, a deterioration-degree acquisition function 74, a measurement-time acquisition function 75, and a necessity calculation function 76.

The reference-time specification function 71 is an example of a reference-time specification unit. The target-position specification function 72 is an example of a target-position specification unit. The measurement-information read function 73 is an example of a measurement-information read unit. The deterioration-degree acquisition function 74 is an example of a deterioration-degree acquisition unit. The measurement-time acquisition function 75 is an example of a measurement-time acquisition unit. The necessity calculation function 76 is an example of a necessity calculation unit.

The reference-time specification function 71 specifies a reference time, which is the reference date and time when the necessity is calculated. The reference time can be the current date and time or an arbitrary date and time. When the reference time is the past date and time, the deterioration management function 52 can provide the necessity at a past point in time. When the reference time is a future date and time, the deterioration management function 52 can provide the necessity at a future point in time.

The target-position specification function 72 specifies the position in a structure at which the necessity is calculated. For example, the target-position specification function 72 receives specification of a position from a user to specify a target position.

The measurement-information read function 73 reads, from the second memory circuit 44, a plurality of pieces of measurement information stored corresponding to the target position. Respective pieces of measurement information include the deterioration degree and the measurement time.

The deterioration-degree acquisition function 74 acquires the deterioration degree from each of the pieces of measurement information read by the measurement-information read function 73. Accordingly, the deterioration-degree acquisition function 74 can acquire the deterioration degrees with respect to the target position. The deterioration-degree acquisition function 74 acquires the deterioration degrees measured at the reference time and before the reference time.

The measurement-time acquisition function 75 acquires the measurement time from each of the pieces of measurement information read by the measurement-information read function 73. Accordingly, the measurement-time acquisition function 75 can acquire the measurement times corresponding to the respective deterioration degrees acquired by the deterioration-degree acquisition function 74. That is, the measurement-time acquisition function 75 can acquire the measurement time expressing the date and time when the image, which is the basis of calculation of the deterioration degree, has been captured for each of the deterioration degrees acquired by the deterioration-degree acquisition function 74.

The necessity calculation function 76 receives the reference time from the reference-time specification function 71. The necessity calculation function 76 receives the plurality of deterioration degrees from the deterioration-degree acquisition function 74. The necessity calculation function 76 receives the plurality of measurement times from the measurement-time acquisition function 75. The necessity calculation function 76 calculates the necessity of additional measurement of the deterioration degree with respect to the target position according to a preset calculation process, based on the plurality of deterioration degrees measured at different measurement times.

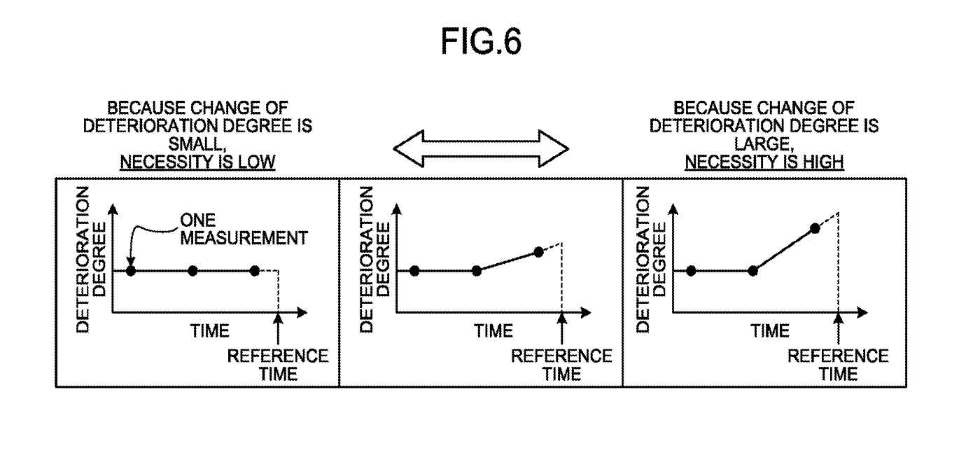

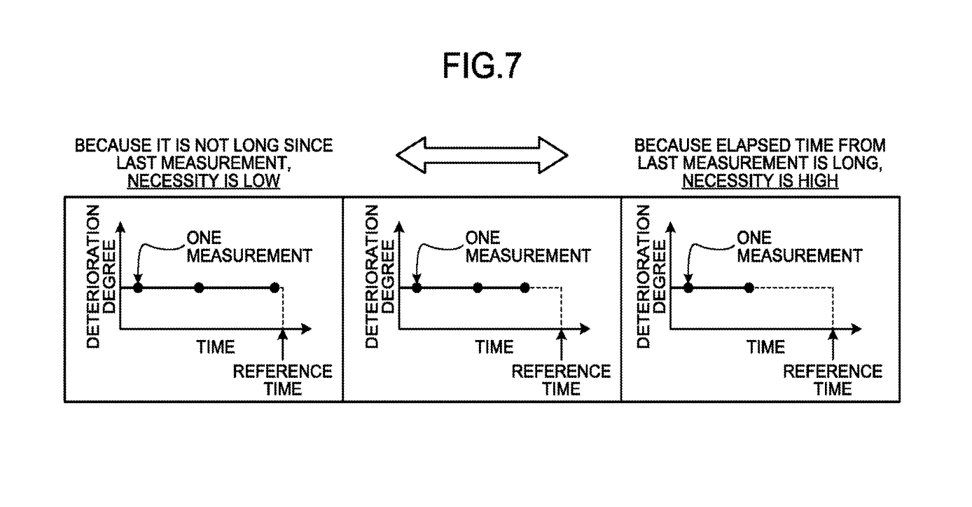

The necessity calculation function 76 calculates the necessity according to the calculation process in which the necessity is increased as a change amount of the deterioration degree per unit time increases. In addition, the calculation process can be a process in which the necessity is increased as an elapsed time from the measurement time to the reference date and time of the necessity calculation increases. The calculation process is described in more detail with reference to FIGS. 6, 7, and the like.

The necessity calculation function 76 can calculate an aggregate deterioration degree with respect to the target position in a structure based on the deterioration degrees measured at different measurement times. The aggregate deterioration degree is a value obtained by weighting the plurality of deterioration degrees measured at different measurement times corresponding to the measurement times and aggregating the deterioration degrees.

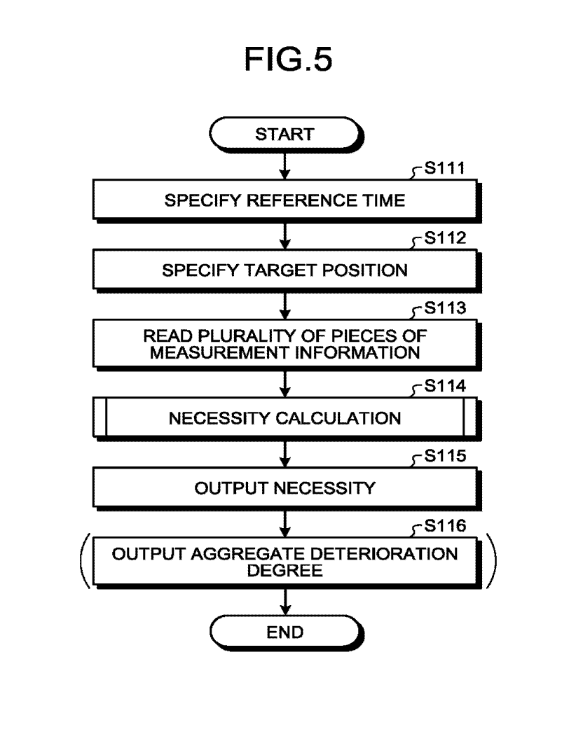

FIG. 5 is a flowchart illustrating a process flow performed by the deterioration management function 52 according to the first embodiment. The deterioration management function 52 performs the process according to the flowchart illustrated in FIG. 5.

The deterioration management function 52 specifies a reference time (S111). Subsequently, the deterioration management function 52 specifies a target position (S112). The deterioration management function 52 then reads plural pieces of measurement information corresponding to the target position (S113). The deterioration management function 52 reads the pieces of measurement information including the deterioration degrees measured at the reference time and before the reference time.

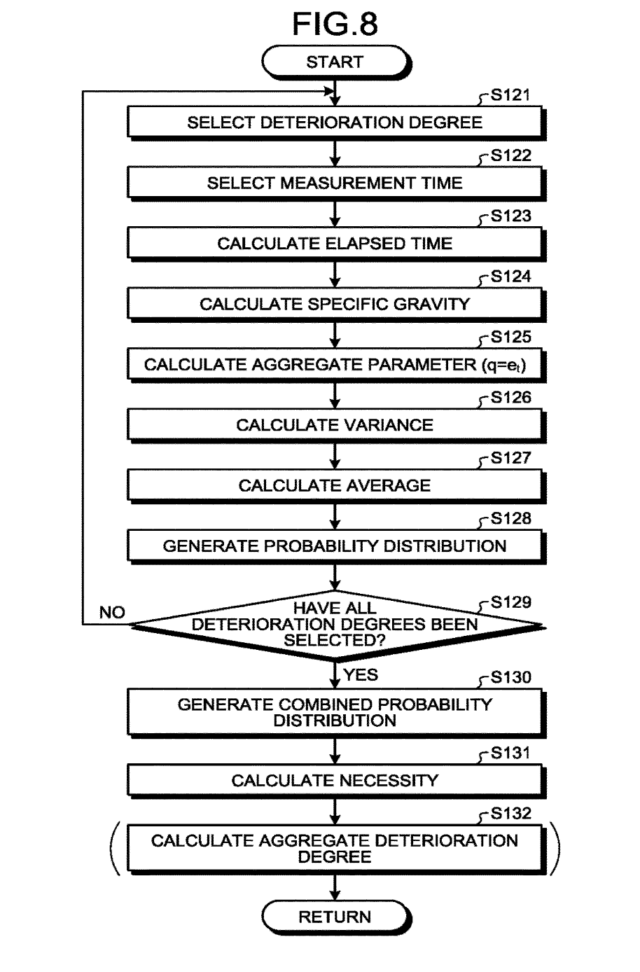

The deterioration management function 52 then calculates the necessity of additional measurement of the deterioration degree with respect to the target position, based on the deterioration degrees measured at different measurement times according to a preset calculation process (S114). The calculation process is a process in which the necessity is increased as a change amount of the deterioration degree per unit time increases. In addition, the calculation process can be a process in which the necessity is increased as an elapsed time from the measurement time to the reference date and time of the necessity calculation increases. A specific processing example at S114 is described in detail with reference to a flowchart in FIG. 8.

Subsequently, the deterioration management function 52 outputs the calculated necessity (S115). For example, the deterioration management function 52 displays the necessity on the display device 42.

Next, when the aggregate deterioration degree has been calculated together with the necessity calculation process, the deterioration management function 52 outputs the aggregate deterioration degree (S116). For example, the deterioration management function 52 displays the aggregate deterioration degree on the display device 42.

FIG. 6 is a first explanatory diagram of the calculation process of calculating the necessity. In FIG. 6, three graphs are illustrated. In FIG. 6, the deterioration degree per unit time is higher in a graph on the right side than in a graph on the left side. In FIG. 6, the calculation process performed by the necessity calculation function 76 indicates that the necessity is increased in the case indicated by the graph on the right side than in the case indicated by the graph on the left side.

As illustrated in FIG. 6, the calculation process performed by the necessity calculation function 76 is to increase the necessity as the change amount of the deterioration degree per unit time increases. Accordingly, when the measurement accuracy of the deterioration degree is low due to, for example, the weather at the time of imaging and the surrounding environments at the time of imaging, or when the deterioration degree worsens, the necessity calculation function 76 can increase the necessity.

FIG. 7 is a second explanatory diagram of the calculation process for calculating the necessity. In FIG. 7, three graphs are illustrated. In FIG. 7, the elapsed time from the measurement time nearest to the reference time until the reference time is longer in a graph on the right side than in a graph on the left side. Further, in FIG. 7, it is indicated that the calculation process performed by the necessity calculation function 76 increases the necessity in the case indicated by the graph on the right side than in the case indicated by the graph on the left side.

The calculation process performed by the necessity calculation function 76 can increase the necessity as the elapsed time increases as illustrated in FIG. 7 in addition to the process illustrated in FIG. 6. For example, when the change amount is the same, the calculation process can increase the necessity as the elapsed time increases. Accordingly, the necessity calculation function 76 can increase the necessity as the possibility of progress in the deterioration increases.

FIG. 8 is a flowchart illustrating a flow of the calculation process of calculating the necessity.

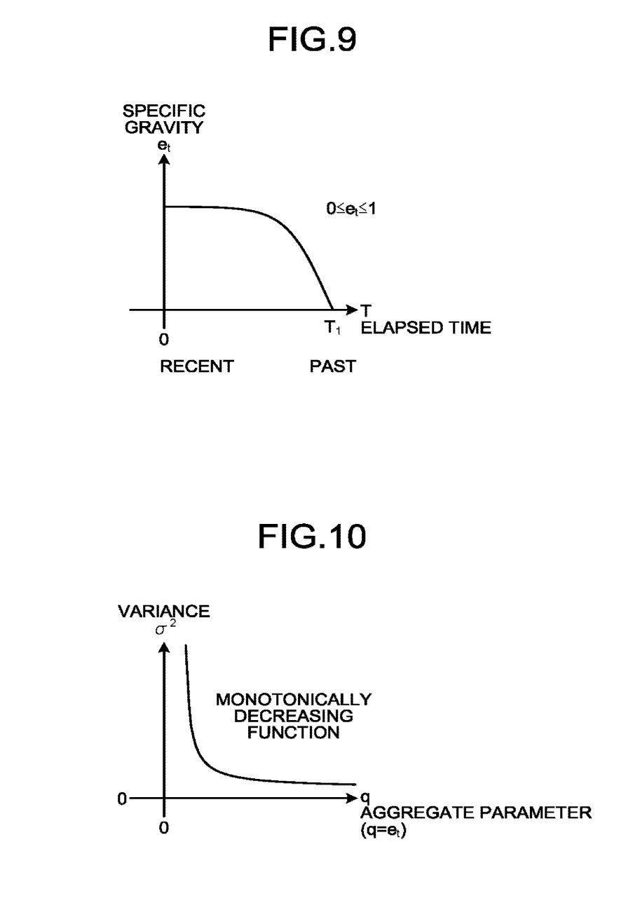

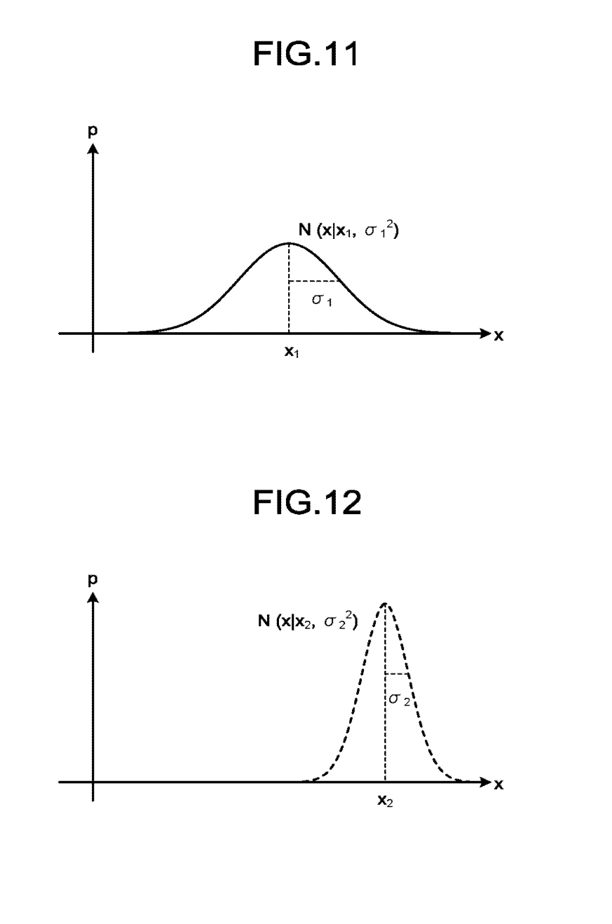

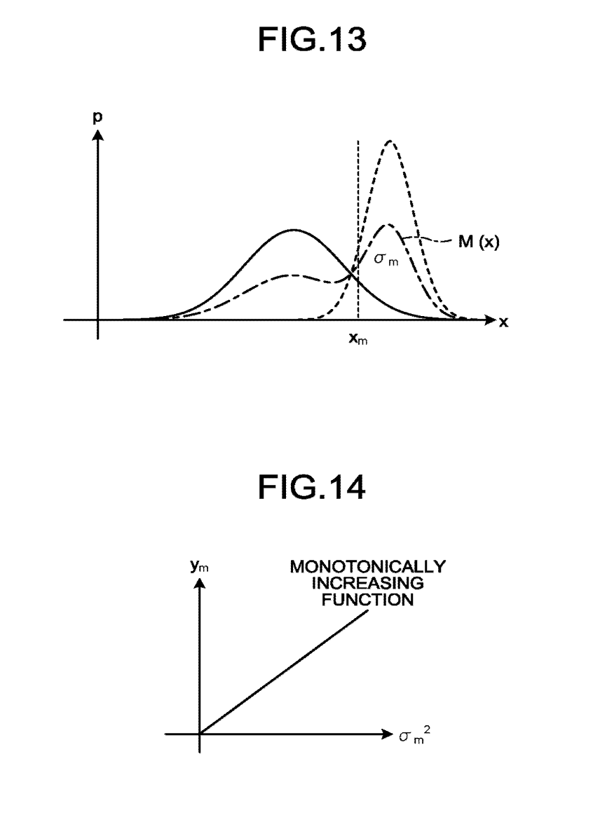

FIG. 9 is a diagram illustrating an example of a first function to be used for calculating a specific gravity at S124. FIG. 10 is a diagram illustrating an example of a second function to be used for calculating variance at S126. FIG. 11 is a diagram illustrating a first example of a probability distribution to be calculated at S128. FIG. 12 is a diagram illustrating a second example of a probability distribution to be calculated at S128. FIG. 13 is a diagram illustrating an example of a combined probability distribution generated at S130. FIG. 14 is a diagram illustrating an example of a third function to be used for calculating the necessity at S131.

At S121, the necessity calculation function 76 selects one of the deterioration degrees measured with respect to a target position before a reference time. Subsequently at S122, the necessity calculation function 76 selects a measurement time corresponding to the selected deterioration degree.

At S123, the necessity calculation function 76 calculates an elapsed time. Specifically, the necessity calculation function 76 subtracts the measurement time from the reference time to calculate an elapsed time. The measurement time is the date and time before the reference time. Accordingly, the elapsed time is a non-negative value.

Next at S124, the necessity calculation function 76 calculates a specific gravity based on the elapsed time.

When it is assumed that the elapsed time is T, and the specific gravity is eₜ, the necessity calculation function 76 calculates the specific gravity by using the first function expressed in the following equation (1).

eₜ=fₐ(T) (1)

For example, the first function is represented by a graph as illustrated in FIG. 9. For example, when T=0, the first function sets eₜ=1, and when T=T₁, the first function sets eₜ=0. T₁ is a preset period, and is for example “1 year”. In a range of 0<T<T₁, the first function decreases eₜ as T increases. For example, in the range of 0<T<T₁, the first function increases a decreasing rate of eₜ as T increases. Further, in a range of T₁<T, the first function sets eₜ to 0.

By using such a first function, the necessity calculation function 76 can calculate a larger specific gravity as the measurement time approaches to the reference time (as the measurement time is closer to the current time). The necessity calculation function 76 can set the specific gravity to 0, with respect to the deterioration degree in the past by a certain period of time.

Subsequently at S125, the necessity calculation function 76 calculates an aggregate parameter based on the specific gravity. When it is assumed that the specific gravity is eₜ, and the aggregate parameter is q, the necessity calculation function 76 calculates the aggregate parameter based on the following equation (2).

q=eₜ (2)

In the equation (2), the aggregate parameter has the same value as the specific gravity. However, the necessity calculation function 76 can set the aggregate parameter to another value, so long as it is based on the specific gravity. For example, the necessity calculation function 76 can set the aggregate parameter to a value proportional to the specific gravity.

Next at S126, the necessity calculation function 76 calculates variance based on the aggregate parameter. When it is assumed that the aggregate parameter is q and variance is σ², the necessity calculation function 76 calculates variance by using the second function expressed in the following equation (3).

σ²=f_{b}(q) (3)

For example, the second function is represented by a graph as illustrated in FIG. 10. That is, the second function is a monotonically decreasing function such that σ² increases as q is closer to 0, and σ² is asymptotic to 0 as q increases. The second function outputs a predetermined positive value when q is 0.

The necessity calculation function 76 can decrease the variance as the measurement time approaches to the reference time (that is, as the deterioration degree is acquired by a newer measurement) by using such a second function. The necessity calculation function 76 can increase the variance as the measurement time is further from the reference time (that is, as the deterioration degree is acquired by an older measurement).

Next at S127, the necessity calculation function 76 calculates an average based on the deterioration degrees. When it is assumed that the deterioration degree is d and the average is x, the necessity calculation function 76 calculates the average based on the following equation (4).

xₖ=d (4)

In the equation (4), the average has the same value as the deterioration degree. However, the necessity calculation function 76 can set the average to another value so long as the value is based on the deterioration degree. For example, the necessity calculation function 76 can set the average to a value proportional to the deterioration degree.

At S128, the necessity calculation function 76 generates a probability distribution, which has the variance calculated at S126 and the average calculated at S127. The probability distribution is, for example, a Gaussian distribution (a normal distribution).

For example, the Gaussian distribution in which the average is x₁ and the variance is σ₁² is expressed as illustrated in FIG. 11. The Gaussian distribution in which the average is x₂ and the variance is σ₂² is expressed as illustrated in FIG. 12. When it is assumed that an arbitrary average is xₖ and an arbitrary variance is σₖ², the Gaussian distribution is expressed by the following expression (5).

N(x|xₖ,σₖ²) (5)

In the Gaussian distribution, the probability has a peak at the average and decreases as moving away from the average. Accordingly, when the deterioration degrees are close to each other, the necessity calculation function 76 generates the Gaussian distributions in which their peaks are close to each other. However, when the deterioration degrees are away from each other, the necessity calculation function 76 generates the Gaussian distributions in which their peaks are away from each other.

The Gaussian distribution is sharper as the variance decreases, and is flatter as the variance increases. Accordingly, the necessity calculation function 76 generates a sharp Gaussian distribution as the measurement time is closer to the reference time (that is, as the deterioration degree is acquired by a newer measurement). The necessity calculation function 76 generates a flat Gaussian distribution as the measurement time is farther from the reference time (that is, as the deterioration degree is acquired by an older measurement).

In this manner, the necessity calculation function 76 generates a probability distribution in which the average is a value based on the deterioration degree, and the variance is a value that decreases as the elapsed time from the measurement time to the reference time decreases.

Next at S129, the necessity calculation function 76 selects all the deterioration degrees measured before the reference time, and determines whether the probability distribution has been generated with respect to each of all the deterioration degrees. When the probability distribution has not been generated with respect to all the deterioration degrees (NO at S129), the necessity calculation function 76 returns the process to S121 to advance the process with respect to the next deterioration degree. When probability distributions have been generated with respect to all the deterioration degrees (YES at S129), the necessity calculation function 76 advances the process to S130.

By performing the processes from S121 to S129, the necessity calculation function 76 can generate the probability distribution in which the average takes a value based on the deterioration degree, and the variance takes a value that decreases as the elapsed time from the measurement time to the reference time of the necessity calculation decreases, with respect to each of the deterioration degrees measured at different measurement times.

At S130, the necessity calculation function 76 combines the probability distributions respectively calculated for the deterioration degrees measured at different measurement times, to generate a combined probability distribution. For example, the necessity calculation function 76 generates a combined probability distribution in which the probability distributions respectively calculated for the deterioration degrees measured at different measurement times are averaged.

For example, a combined probability distribution obtained by combining the Gaussian distributions as illustrated in FIG. 11 and FIG. 12 is expressed as illustrated in FIG. 13. For example, when it is assumed that K denotes the number of deterioration degrees and M(x) denotes the combined probability distribution, the necessity calculation function 76 calculates the combined probability distribution based on the following equation (6).

$$M ( x ) = \frac{1}{K} {\sum }_{k = 1}^{K} N ( x \vert {x}_{k} , {σ}_{k}^{2} ) \qquad ( 6 )$$

The variance (σₘ²) in the combined probability distribution is represented by the following equation (7).

σₘ²=∫₀¹(x−xₘ)²M(x)dx (7)

The average (xₘ) in the combined probability distribution is represented by the following equation (8).

xₘ=∫₀¹(xM(x)dx (8)

At S131, the necessity calculation function 76 calculates the necessity based on the variance in the combined probability distribution. When it is assumed that the variance in the combined probability distribution is σₘ² and the necessity is yₘ, the necessity calculation function 76 calculates the necessity by using a third function expressed in the following equation (9).

yₘ=f_{c}(σₘ²) (9)

The third function is expressed by, for example, a graph illustrated in FIG. 14. That is, the third function is a monotonically increasing function that outputs a value that increases as the variance in the combined probability distribution increases. For example, the third function can be yₘ=σₘ².

At S132, the necessity calculation function 76 calculates an aggregate deterioration degree based on the average of the combined probability distribution. When it is assumed that the average of the combined probability distribution is xₘ and the aggregate deterioration degree is dₘ, the necessity calculation function 76 calculates the aggregate deterioration degree based on the following equation (10).

dₘ=xₘ (10)

In the equation (10), the aggregate deterioration degree is assumed to be the same value as the average of the combined probability distribution. However, the necessity calculation function 76 can set the aggregate deterioration degree to another value so long as the value is based on the average of the combined probability distribution. For example, the necessity calculation function 76 can set the aggregate deterioration degree to a value proportional to the average of the combined probability distribution.

The necessity calculation function 76 may not perform the process at S132, when the aggregate deterioration degree is not output. When the process at S132 is finished, the necessity calculation function 76 returns the process to the main flow.

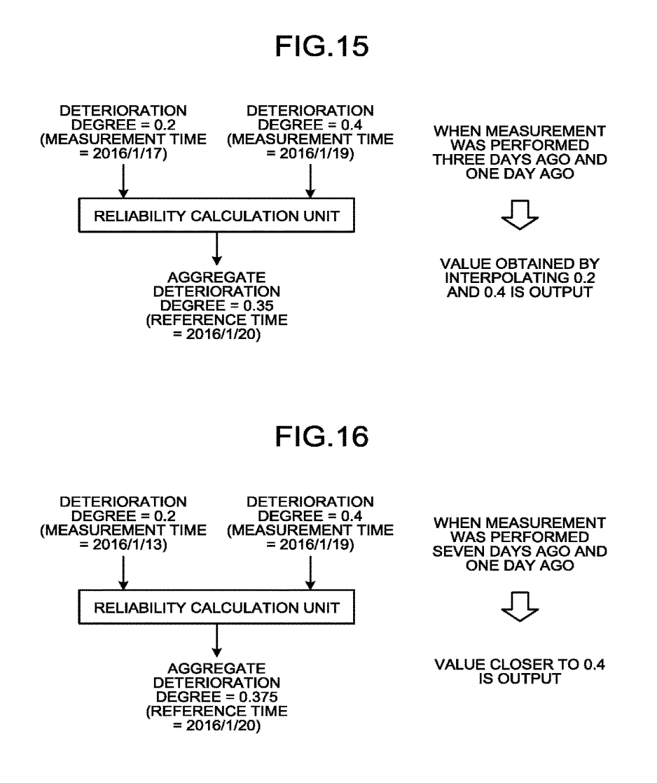

FIG. 15 is a diagram illustrating an example of the aggregate deterioration degree obtained from two deterioration degrees respectively measured three days ago and one day ago. FIG. 16 is a diagram illustrating an example of the aggregate deterioration degree obtained from two deterioration degrees respectively measured seven days ago and one day ago.

The necessity calculation function 76 outputs the average of the combined probability distribution as the aggregate deterioration degree. For example, as illustrated in FIG. 15, it is assumed that the deterioration degree measured three days ago is 0.2 and the deterioration degree measured one day ago is 0.4. In this case, the necessity calculation function 76 outputs, for example, 0.35 as the aggregate deterioration degree. 0.35 is a value closer to the deterioration degree measured one day ago than the deterioration degree measured three days ago.

Further, for example, as illustrated in FIG. 16, it is assumed that the deterioration degree measured seven days ago is 0.2 and the deterioration degree measured one day ago is 0.4. In this case, the necessity calculation function 76 outputs, for example, 0.375 as the aggregate deterioration degree. 0.375 is a value closer to the deterioration degree measured one day ago than the deterioration degree measured seven days ago.

In this manner, the necessity calculation function 76 outputs, as the aggregate deterioration degree, a value obtained by interpolating the deterioration degree by increasing the weight as the measurement time approaches to the reference time (that is, as the deterioration degree is acquired by a newer measurement). Accordingly, the necessity calculation function 76 can output an aggregate deterioration degree with high accuracy.

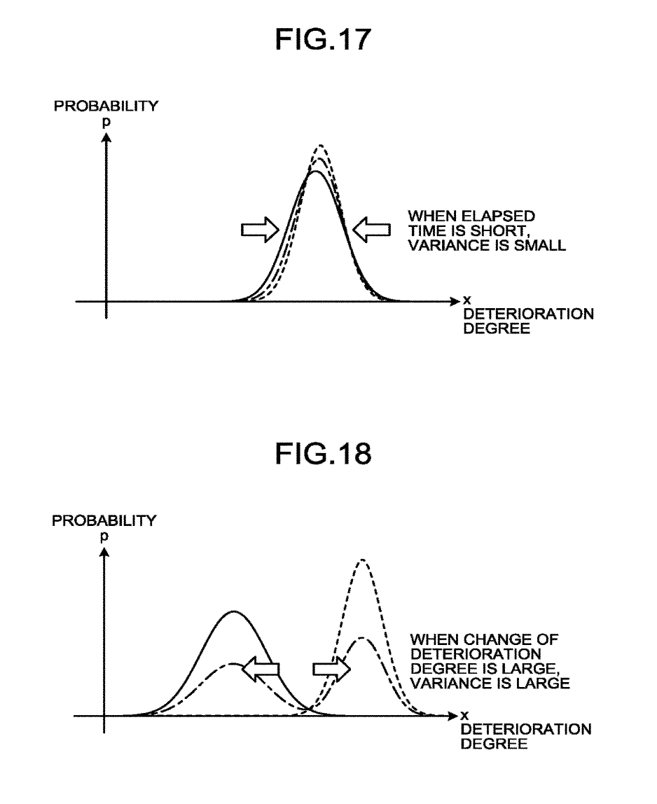

FIG. 17 is a diagram illustrating an example of a plurality of probability distributions when the elapsed time is short and a change amount of the deterioration degree is small. When the elapsed time is short, the necessity calculation function 76 generates a probability distribution having small variance. Further, when the change amount of the deterioration degree is small (that is, the deterioration degrees are close to each other), the necessity calculation function 76 generates a plurality of probability distributions in which their peak positions are close to each other.

When such a plurality of probability distributions are combined, the necessity calculation function 76 generates a sharp combined probability distribution having small variance. Therefore, when the elapsed time is short and the change amount of the deterioration degree is small, the necessity calculation function 76 can decrease the necessity.

FIG. 18 is a diagram illustrating an example of a plurality of probability distributions when the change amount of the deterioration degree is large. When the change amount of the deterioration degree is large (that is, the deterioration degrees are away from each other), the necessity calculation function 76 generates a plurality of probability distributions in which their peaks are away from each other.

When such probability distributions are combined, the necessity calculation function 76 generates a flat combined probability distribution having large variance. Therefore, when the change amount of the deterioration degree is large, the necessity calculation function 76 can increase the necessity.

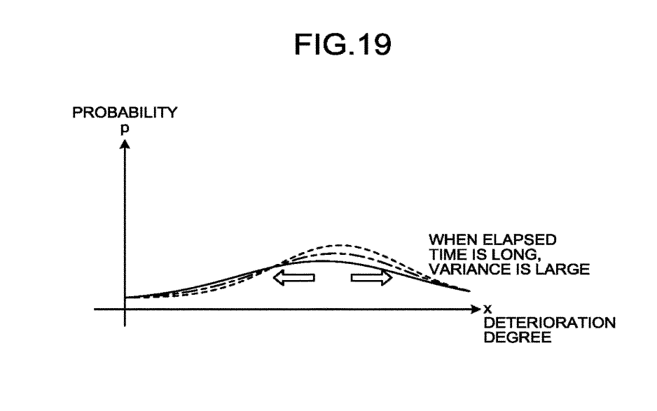

FIG. 19 is a diagram illustrating an example of a plurality of probability distributions when the elapsed time is long and the change amount of the deterioration degree is small. When the elapsed time is long, the necessity calculation function 76 generates a probability distribution having large variance.

When such probability distributions are combined, the necessity calculation function 76 generates a flat combined probability distribution having large variance. Therefore, for example, even if the change amount of the deterioration degree is the same, the necessity calculation function 76 can increase the necessity when the elapsed time is long.

As described above, the necessity calculation function 76 can calculate the necessity through a calculation process of increasing the necessity as the change amount of the deterioration degree increases. Further, the necessity calculation function 76 can calculate the necessity through a calculation process of increasing the necessity as the elapsed time from the measurement time to the reference date and time of necessity calculation increases.

Consequently, according to the deterioration management system 10, the necessity of additional measurement of the deterioration degree can be accurately calculated.

The necessity calculation function 76 can calculate the necessity not only by using the above method, but also by using other calculation processes having a similar tendency. For example, the necessity calculation function 76 can calculate the necessity by using a calculation process expressed by the following equation (11).

yₘ=w₀×(1/qₘ)+w₁×σₓ² (11)

In the equation (11), qₘ denotes a mean value of an aggregate parameter calculated from the specific gravity based on the elapsed times of the respective deterioration degrees. σₓ² denotes variance of the deterioration degrees, and yₘ denotes the necessity. w₀ and w₁ are preset coefficients for linearly adding a first term and a second term.

The first term of the equation (11) increases as the elapsed times of the respective deterioration degrees increase. The second term increases as the variance of the deterioration degrees increases. The equation (11) can increase the necessity as the change amount of the deterioration degree increases, and can increase the necessity as the elapsed time increases. Therefore, the necessity calculation function 76 can calculate the necessity with high accuracy, as in the case of using the probability distribution, by calculating the necessity by using the equation (11). The equation (11) can include a parameter representing a mean value or a total value of the elapsed time, instead of 1/qₘ.

Further, the necessity calculation function 76 can perform a process of excluding an influence of the deterioration degree measured in the past by a certain period of time. Accordingly, the necessity calculation function 76 can exclude a measurement result that is too old to be used as a reference.

### Modification of First Embodiment

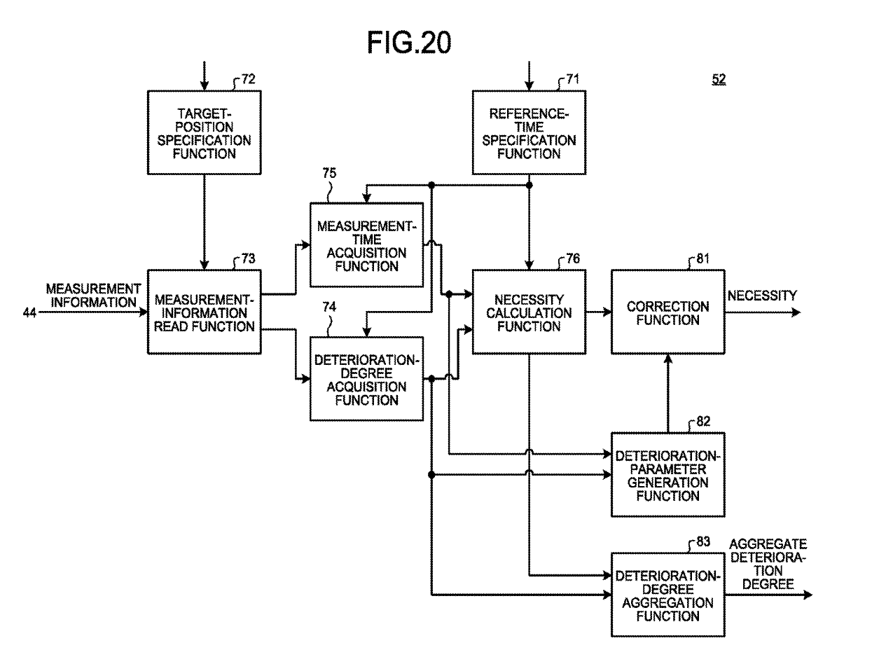

FIG. 20 is a diagram illustrating a configuration of the deterioration management function 52 according to a modification of the first embodiment. The deterioration management function 52 according to the modification of the first embodiment further includes a correction function 81, a deterioration-parameter generation function 82, and a deterioration-degree aggregation function 83 in addition to the configuration of the first embodiment. The correction function 81 is an example of a correction unit. The deterioration-parameter generation function 82 is an example of a deterioration-parameter generation unit. The deterioration-degree aggregation function 83 is an example of a deterioration-degree aggregation unit.

The correction function 81 corrects the necessity output from the necessity calculation function 76 based on a provided parameter. The correction function 81 outputs a corrected necessity. In the present modification, the correction function 81 corrects the necessity based on a deterioration parameter received from the deterioration-parameter generation function 82.

The deterioration-parameter generation function 82 receives a plurality of deterioration degrees measured at different measurement times with respect to a target position. The deterioration-parameter generation function 82 also receives measurement times respectively corresponding to the deterioration degrees received from the measurement-time acquisition function 75. The deterioration-parameter generation function 82 calculates a deterioration parameter based on the received deterioration degrees and the measurement times corresponding thereto.

The deterioration parameter is a parameter indicating whether the deterioration degree has changed in a direction of improving with time, or the deterioration degree has changed in a direction of worsening with time. The correction function 81 increases the necessity in a case where the deterioration degree has changed in the direction of worsening with time than a case where the deterioration degree has changed in the direction of improving with time, based on the deterioration parameter.

It is assumed here that the necessity before the correction is yₘ, the deterioration parameter is g_{d}, and the necessity after the correction is y. In this case, the correction function 81 corrects the necessity, for example, as expressed in the following equation (12).

y=yₘ×g_{d} (12)

When the correction function 81 corrects the necessity as expressed in the equation (12), the deterioration-parameter generation function 82 sets the g_{d} to 1 in the case where the deterioration degree has changed in the direction of improving with time, and sets the g_{d} to a value larger than 1 in the case where the deterioration degree has changed in the direction of worsening with time.

Alternatively, the correction function 81 can correct the necessity as expressed in the following equation (13).

y=yₘ+g_{d} (13)

When the correction function 81 corrects the necessity as expressed in the equation (13), the deterioration-parameter generation function 82 sets the g_{d} to 0 in the case where the deterioration degree has changed in the direction of improving with time, and sets the g_{d} to a value larger than 0 in the case where the deterioration degree has changed in the direction of worsening with time.

In this manner, the deterioration management function 52 according to the present modification can increase the necessity in a case where the deterioration degree has changed in the direction of worsening with time than a case where the deterioration degree has changed in the direction of improving with time.

The deterioration-degree aggregation function 83 receives the deterioration degrees measured at different measurement times. Further, the deterioration-degree aggregation function 83 receives the aggregate parameters respectively calculated for the deterioration degrees received from the necessity calculation function 76. The aggregate parameter has a larger value as the measurement time of the deterioration degree is closer to the reference time (that is, as the deterioration degree is acquired by a newer measurement).

The deterioration-degree aggregation function 83 weights each of the received deterioration degrees with the corresponding aggregate parameter and calculates a mean value of the weighted deterioration degrees. The deterioration-degree aggregation function 83 outputs the calculated mean value as the aggregate deterioration degree. Accordingly, the deterioration-degree aggregation function 83 can output the aggregate deterioration degree instead of the necessity calculation function 76.

The deterioration management function 52 according to the present modification can have a configuration of not including the deterioration-degree aggregation function 83. Further, the deterioration management function 52 according to the present modification can have a configuration of not including the correction function 81 and the deterioration-parameter generation function 82.

### Second Embodiment

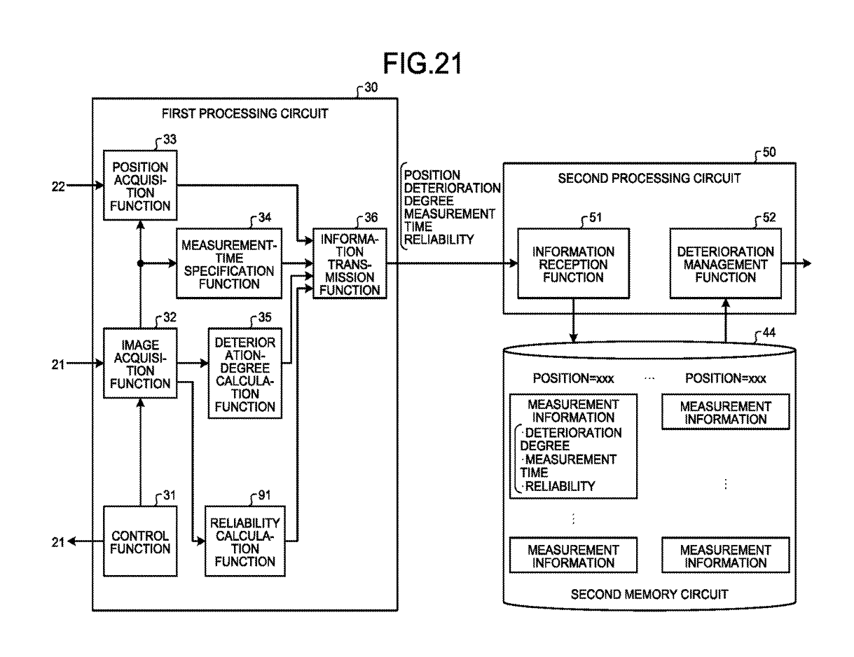

FIG. 21 is a diagram illustrating configurations of the first processing circuit 30 and the second processing circuit 50 according to a second embodiment. The deterioration management system 10 according to the second embodiment further calculates reliability with respect to a calculated deterioration degree and calculates the necessity by also using the calculated reliability.

The first processing circuit 30 according to the second embodiment further includes a reliability calculation function 91 in addition to the configuration of the first embodiment. The reliability calculation function 91 is an example of a reliability calculation unit. The reliability calculation function 91 calculates the reliability with respect to a deterioration degree calculated by the deterioration-degree calculation function 35, based on the environment in which an image has been captured.

The deterioration degree varies depending on the environment in which an image has been captured. For example, the deterioration degree calculated based on an image captured in a favorable environment has high reliability. On the other hand, the deterioration degree calculated based on an image captured in an unfavorable environment has low reliability. The reliability calculation function 91 evaluates and quantifies the reliability.

The reliability can be a numerical value, for example, of from 0.0 to 1.0 inclusive. Further, the reliability can be a numerical value, for example, of from 0 to 100 inclusive. The reliability can be information representing a plurality of levels.

The information transmission function 36 transmits the position in a structure where an image being the basis of calculation of the deterioration degree has been captured, the deterioration degree, the measurement time, and the reliability to the information processing apparatus 40. The information reception function 51 of the second processing circuit 50 receives the position, the deterioration degree, the measurement time, and the reliability from the mobile apparatus 20.

The information reception function 51 stores measurement information including the received deterioration degree, measurement time, and reliability in the second memory circuit 44 for each position. The second memory circuit 44 can store therein the position, the deterioration degree, the measurement time, and the reliability by any method, so long as, by being specified of the position, the deterioration degree, the measurement time, and the reliability corresponding to the position can be read. For example, the second memory circuit 44 can add a unique ID set to each calculation process to each of the position, the deterioration degree, the measurement time, and the reliability.

The reliability calculation function 91 can be provided not in the first processing circuit 30 but in the second processing circuit 50. In this case, the information transmission function 36 of the first processing circuit 30 collects pieces of information required for calculating the reliability and transmits the information to the second processing circuit 50 together with the deterioration degree. The reliability calculation function 91 of the second processing circuit 50 calculates the reliability based on the information transmitted from the first processing circuit 30.

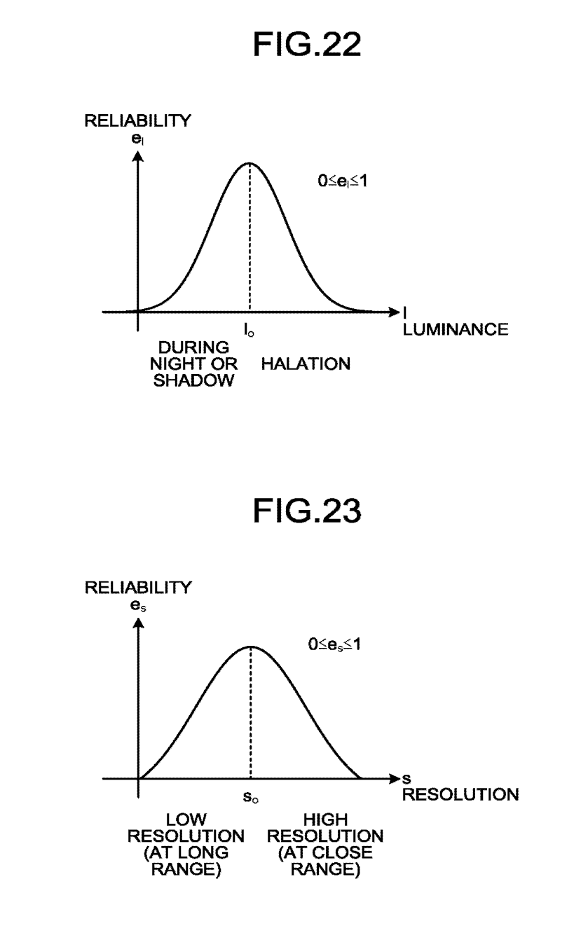

FIG. 22 is a diagram illustrating an example of a graph representing the reliability with respect to a luminance. The reliability calculation function 91 can acquire an image that is the basis of calculation of the deterioration degree to calculate the reliability that increases as the luminance of the acquired image approaches to a preset reference luminance.

The reliability with respect to the deterioration degree changes depending on the weather, a time slot, and the like at the time of imaging a structure. For example, for an image obtained by imaging a structure in a state in which brightness is ensured sufficiently in a time slot during the day without any shadow, the deterioration degree can be calculated with high reliability. However, for an image obtained by imaging the structure in a state in which sufficient brightness is not ensured in the evening or during the night, or an image in which a shadow is cast on the structure, a highly reliable deterioration degree cannot be calculated. Further, for an image that is too bright to cause halation, a highly reliable deterioration degree cannot be calculated.

Therefore, the reliability calculation function 91 acquires an image beforehand by imaging the structure in a state in which brightness is ensured sufficiently in a time slot during the day and capturing an image without any shadow. The reliability calculation function 91 stores therein an average luminance of such adequate images as a reference luminance.

When the deterioration degree has been calculated, the reliability calculation function 91 calculates the average luminance of the image that is the basis of calculation of the deterioration degree as a measured luminance, and calculates a difference between the measured luminance and the reference luminance. When the difference is 0, the reliability calculation function 91 sets the reliability to the highest level, and lowers the reliability as the difference increases. For example, the reliability calculation function 91 can calculate the reliability (e₁) by a function as illustrated in FIG. 22. The e₁ is 1 when the difference between the measured luminance (l) and the reference luminance (l₀) is 0, and as the difference increases, the e₁ approaches to 0. Accordingly, the reliability calculation function 91 can calculate the reliability that increases when the image has appropriate brightness without any shadow, and decreases when the image has been taken during the night or has a shadow or halation.

FIG. 23 is a diagram illustrating an example of a graph representing the reliability with respect to the resolution. The reliability calculation function 91 can acquire an image that is the basis of calculation of the deterioration degree, and calculate the reliability that increases as the resolution of the structure in the acquired image approaches to a preset reference resolution.

The reliability with respect to the deterioration degree changes depending on the resolution of the structure. For example, for an image in which the resolution of the structure is too high because the structure has been imaged from a position too close thereto, or an image in which the resolution of the structure is too low because the structure has been imaged from a position too far away, a highly reliable deterioration degree cannot be calculated. For example, the resolution of a structure by which an accurate deterioration degree can be calculated can be specified beforehand through machine learning or the like.

Therefore, the reliability calculation function 91 acquires beforehand the resolution by which an accurate deterioration degree can be calculated. The reliability calculation function 91 stores therein such an appropriate resolution as a reference resolution.

When the deterioration degree has been calculated, the reliability calculation function 91 calculates the resolution of the structure in the image being the basis of calculation of the deterioration degree as a measured resolution, to calculate a difference between the measured resolution and the reference resolution. When the difference is 0, the reliability calculation function 91 sets the reliability to the highest level, and lowers the reliability as the difference increases. For example, the reliability calculation function 91 can calculate the reliability (eₛ) by a function as illustrated in FIG. 23. The eₛ is 1 when the difference between the measured resolution (s) and the reference resolution (s₀) is 0, and approaches to 0 as the difference increases. Accordingly, the reliability calculation function 91 can calculate the reliability that is high in a case of an image obtained by imaging a structure at an appropriate range, and is low in a case of an image obtained by imaging the structure at a close range (high resolution) or an image obtained by imaging the structure at a long range (low resolution).

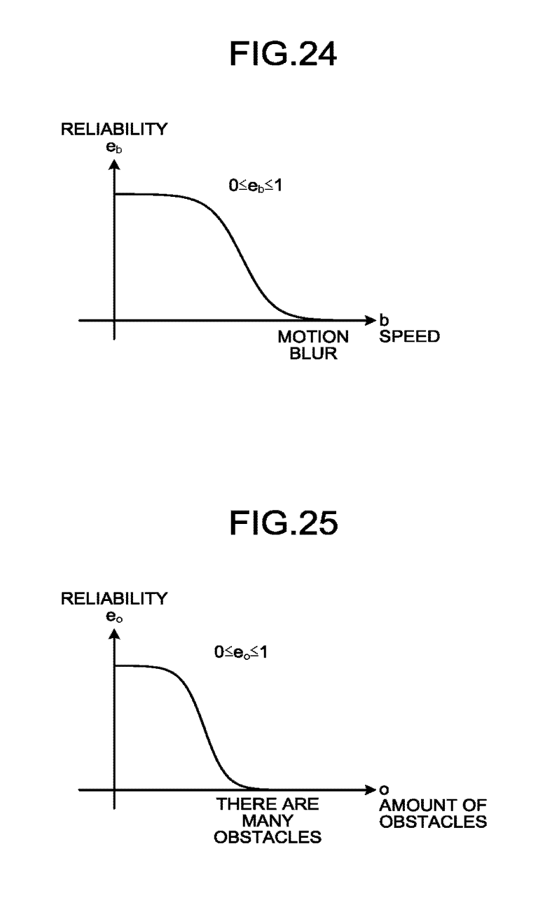

FIG. 24 is a diagram illustrating an example of a graph representing the reliability with respect to a moving speed. The imaging device 21 is mounted on the mobile apparatus 20 to image a structure, for example, while moving. The reliability calculation function 91 specifies the moving speed of, for example, the mobile apparatus 20 as the moving speed of the imaging device 21. The reliability calculation function 91 can calculate the reliability that increases as the moving speed of the imaging device 21 at the time of capturing an image decreases.

In the image captured by the imaging device 21, motion blur occurs corresponding to the moving speed of the imaging device 21. Therefore, the reliability with respect to the deterioration degree changes depending on the moving speed of the imaging device 21. Specifically, the reliability with respect to the deterioration degree increases as the moving speed of the imaging device 21 decreases.

When the deterioration degree has been calculated, the reliability calculation function 91 acquires the moving speed of the imaging device 21 at the time of capturing the image that is the basis of calculation of the deterioration degree. When the acquired moving speed is 0, the reliability calculation function 91 increases the reliability to the highest level, and decreases the reliability as the moving speed increases. For example, the reliability calculation function 91 can calculate the reliability (e_{b}) by a function as illustrated in FIG. 24. The e_{b} is 1 when the moving speed (b) is 0, and approaches to 0 as the moving speed (b) increases. Accordingly, the reliability calculation function 91 can calculate the reliability that is high when the moving speed of the imaging device 21 is slow (when motion blur does not occur), and is low when the moving speed of the imaging device 21 is fast (when motion blur occurs).

FIG. 25 is a diagram illustrating an example of a graph representing the reliability with respect to the amount of obstacles. The reliability calculation function 91 acquires the image that is the basis of calculation of the deterioration degree, and detects the amount of obstacles included in the acquired image. The reliability calculation function 91 can calculate the reliability that increases as the amount of obstacles included in the image decreases.

At the time of capturing an image, a pedestrian, a vehicle, or other obstacles may be included in the image. The reliability with respect to the deterioration degree changes depending on the number of such obstacles. Specifically, the reliability with respect to the deterioration degree increases as the amount of obstacles included in the image decreases, and decreases as the amount of obstacles increases.

When the deterioration degree has been calculated, the reliability calculation function 91 acquires the image that is the basis of calculation of the deterioration degree, and detects the amount of obstacles included in the image. For example, the reliability calculation function 91 analyzes the image and detects an area occupied by the obstacles in a measurement target range, an area ratio, or the number of obstacles as the amount of obstacles. The reliability calculation function 91 increases the reliability to the highest level when the amount of obstacles is 0, and decreases the reliability as the amount of obstacles increases. For example, the reliability calculation function 91 can calculate the reliability (eₒ) by a function as illustrated in FIG. 25. The eₒ is 1 when the amount of obstacles (o) is 0, and approaches to 0 as the amount of obstacles (o) increases. Accordingly, the reliability calculation function 91 can calculate the reliability that is high when the amount of obstacles is small, and is low when the amount of obstacles is large.

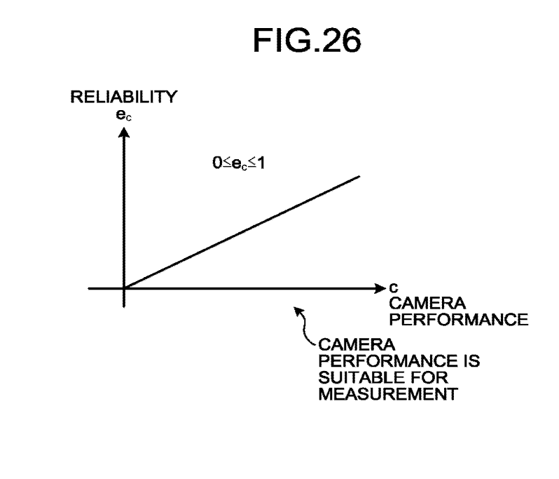

FIG. 26 is a diagram illustrating an example of a graph representing the reliability with respect to camera performance. The reliability calculation function 91 can acquire the camera performance representing the performance of the imaging device 21 that has captured the image being the basis of calculation of the deterioration degree, and calculate the reliability that increases as the camera performance increases.

Various types of imaging devices 21 are used for capturing an image. The reliability with respect to the deterioration degree changes depending on the camera performance representing the performance of the imaging device 21. Specifically, the reliability with respect to the deterioration degree increases as the camera performance increases.

When the deterioration degree has been calculated, the reliability calculation function 91 acquires camera information at the time of capturing the image being the basis of calculation of the deterioration degree. The camera information is information of, for example, the size and the system of an imaging element (image sensor), the number of pixels, focal length, F value, optical zoom, presence of an image stabilizer, ISO, shutter speed, presence of flash, and the like. The reliability calculation function 91 calculates the camera performance based on the camera information. The reliability calculation function 91 can directly designate any value in the camera information as the camera performance. Further, the reliability calculation function 91 can hold the camera information appropriate for measurement of the deterioration degree beforehand, calculate a degree of coincidence between the acquired camera information and the appropriate camera information held beforehand, and increase the camera performance as the degree of coincidence increases.

The reliability calculation function 91 increases the reliability as the calculated camera performance increases. For example, the reliability calculation function 91 can calculate the reliability (e_{c}) by a function as illustrated in FIG. 26. The e_{c} is 1 when the camera performance (c) is the highest, and approaches to 0 as the camera performance (c) decreases. Accordingly, the reliability calculation function 91 can calculate the reliability that increases when the camera performance is high and decreases when the camera performance is low.

The reliability calculation function 91 can calculate the reliability obtained by combining two or more of the reliability (eₗ) based on the luminance, the reliability (eₛ) based on the resolution, the reliability (e_{b}) based on the moving speed, the reliability (eₒ) based on the amount of obstacles, and the reliability (e_{c}) based on the camera performance. In this case, the reliability calculation function 91 calculates the reliability combined by multiplying these reliabilities. For example, the reliability calculation function 91 can calculate combined reliability (r) by combining the reliability (eₗ) based on the luminance, the reliability (eₛ) based on the resolution, the reliability (e_{b}) based on the moving speed, the reliability (eₒ) based on the amount of obstacles, and the reliability (e_{c}) based on the camera performance, as expressed in the following equation (14).

r=eₗ×eₛ×e_{b}×eₒ×e_{c} (14)

(0≦r≦1)

The combined reliability (r) can be a numerical value of from 0.0 to 1.0 inclusive. An example of calculating the combined reliability (r) based on the five factors is described here. However, the reliability calculation function 91 can calculate the combined reliability (r) by also using the reliability based on another factor.

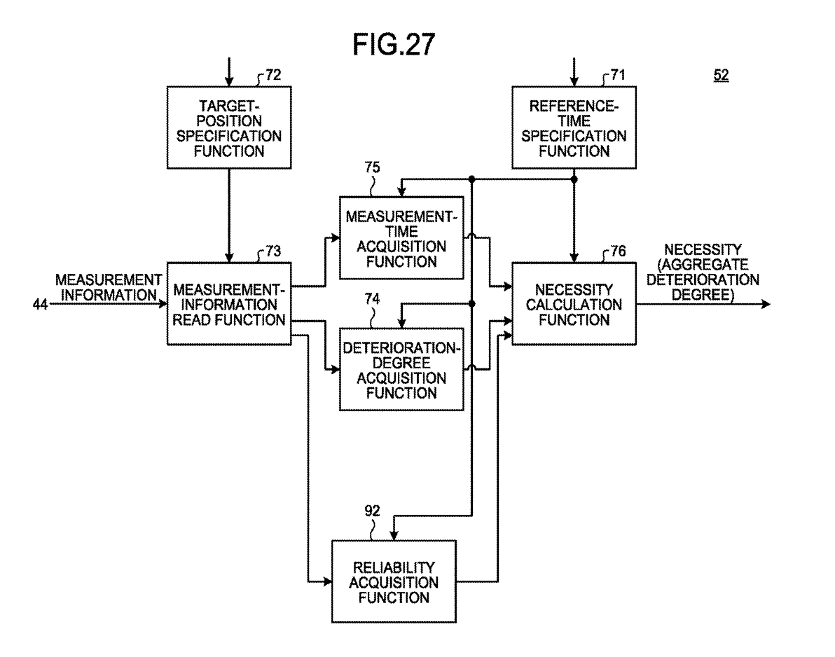

FIG. 27 is a diagram illustrating a configuration of the deterioration management function 52 according to the second embodiment. The deterioration management function 52 further includes a reliability acquisition function 92 in addition to the configuration of the first embodiment. The reliability acquisition function 92 is an example of a reliability acquisition unit.

The reliability acquisition function 92 acquires the reliability with respect to the deterioration degree acquired by the deterioration-degree acquisition function 74 from each of the pieces of measurement information read out by the measurement-information read function 73. The necessity calculation function 76 receives the pieces of reliability information acquired by the reliability acquisition function 92. The necessity calculation function 76 calculates the necessity of additional measurement of the deterioration degree through a preset calculation process, based on the plurality of deterioration degrees measured at different times and the reliability. In this case, the calculation process is a process of increasing the necessity as the reliability decreases.

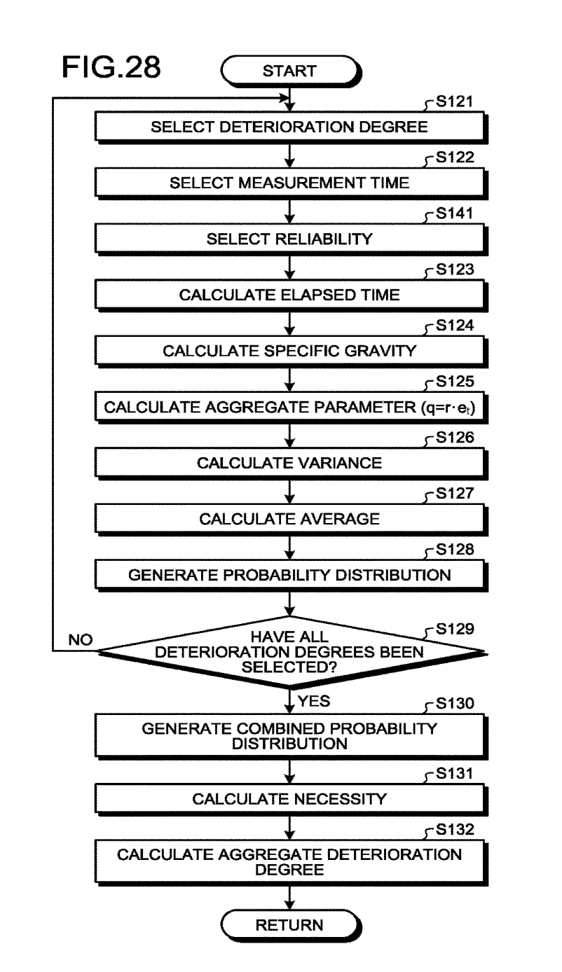

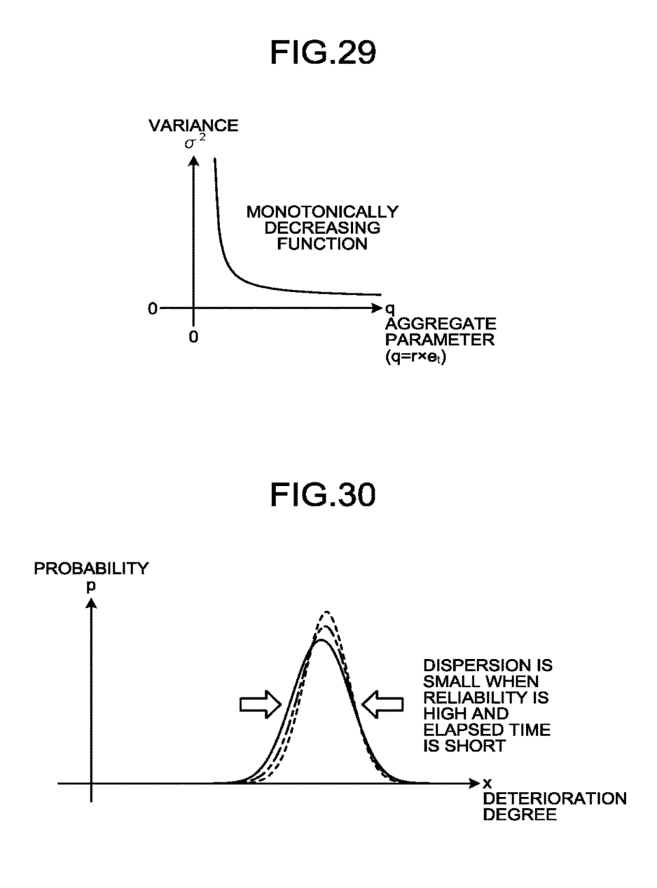

FIG. 28 is a flowchart illustrating a flow of the calculation process of calculating the necessity by the necessity calculation function 76 in the second embodiment. FIG. 29 is a diagram illustrating an example of a fourth function to be used for calculating the variance at S126. The process performed by the necessity calculation function 76 is substantially the same as the process described in FIG. 8, and thus the differences therebetween are mainly described here.

The necessity calculation function 76 advances the process to S141 after the process at S122. At S141, the necessity calculation function 76 selects the reliability corresponding to the deterioration degree selected at S121. The necessity calculation function 76 advances the process to S123 after finishing the process at S141.

At S125, the necessity calculation function 76 calculates the aggregate parameter based on the specific gravity calculated at S124 and the reliability selected at S141. When it is assumed that the specific gravity is eₜ, the reliability is r, and the aggregate parameter is q, the necessity calculation function 76 calculates the aggregate parameter based on the following equation (15).

q=eₜ×r (15)

In the equation (15), the aggregate parameter is obtained by multiplying the specific gravity by the reliability. However, the necessity calculation function 76 can set the aggregate parameter to another value, so long as the value is based on a value obtained by multiplying the specific gravity by the reliability. For example, the necessity calculation function 76 can set the aggregate parameter to a value proportional to a value obtained by multiplying the specific gravity by the reliability.

Next at S126, the necessity calculation function 76 calculates the variance based on the aggregate parameter. When it is assumed that the aggregate parameter is q and the variance is σ², the necessity calculation function 76 calculates the variance by the fourth function expressed in the following equation (16).

σ²=f_{d}(q) (16)

The fourth function is, for example, a function represented by a graph as illustrated in FIG. 29. That is, the fourth function is a monotonically decreasing function to increase the σ² as the q being the value obtained by multiplying the specific gravity by the reliability approaches to 0, and approximates the σ² to 0 as the q being the value obtained by multiplying the specific gravity by the reliability increases.

The necessity calculation function 76 can decrease the variance as the measurement time approaches to the reference time and the reliability increases, and can increase the variance as the measurement time is far from the reference time and the reliability decreases.

FIG. 30 is a diagram illustrating an example of a plurality of probability distributions in a case where the reliability is high, the elapsed time is short, and the change amount of the deterioration degree is small. The necessity calculation function 76 generates a probability distribution having small variance when the reliability is high and the elapsed time is short. Further, the necessity calculation function 76 generates a plurality of probability distributions in which their respective peaks are close to each other when the change amount of the deterioration degree is small (that is, the plurality of deterioration degrees are close to each other).

When the necessity calculation function 76 combines such a plurality of probability distributions, the necessity calculation function 76 generates a sharp combined probability distribution having small variance. Therefore, when the reliability is high, the elapsed time is short, and the change amount of the deterioration degree is small, the necessity calculation function 76 can decrease the necessity.

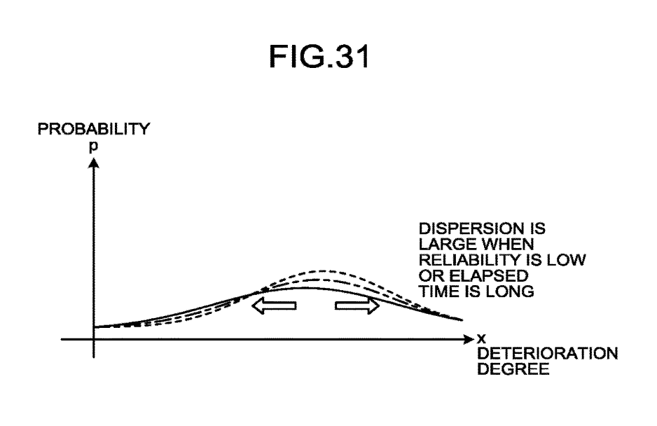

FIG. 31 is a diagram illustrating an example of a plurality of probability distributions in a case where the reliability is low or the elapsed time is long and the change amount of the deterioration degree is small. The necessity calculation function 76 generates a probability distribution having large variance when the reliability is low.

When such probability distributions are combined, the necessity calculation function 76 generates a flat combined probability distribution having large variance. Therefore, even if the change amount of the deterioration degree is the same, the necessity calculation function 76 can increase the necessity when the reliability is low.

As described above, the necessity calculation function 76 can calculate the necessity according to a calculation process in which the necessity is increased as the reliability decreases. Consequently, according to the deterioration management system 10 of the second embodiment, the necessity of additional measurement of the deterioration degree can be calculated accurately. The necessity calculation function 76 can calculate the necessity by using not only the above method but also a calculation process having a similar tendency.

The necessity calculation function 76 outputs an average of the combined probability distribution as an aggregate deterioration degree. Therefore, the necessity calculation function 76 can output the aggregate deterioration degree obtained by interpolating the deterioration degree by increasing a weight as the reliability increases.

### Modification of Second Embodiment

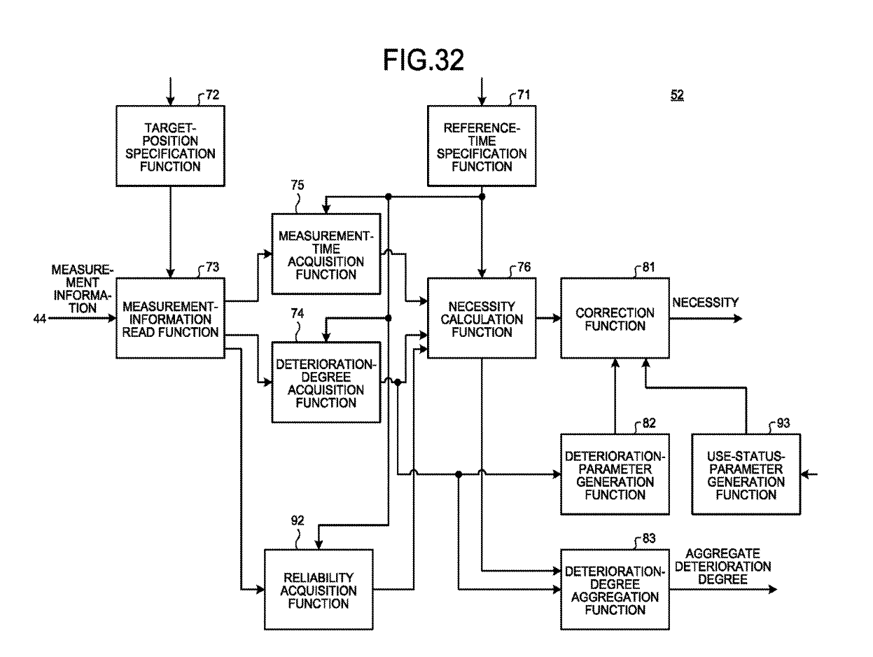

FIG. 32 is a diagram illustrating a configuration of the deterioration management function 52 according to a modification of the second embodiment. The deterioration management function 52 according to the modification of the second embodiment further includes the correction function 81, the deterioration-parameter generation function 82, the deterioration-degree aggregation function 83, and a use-status-parameter generation function 93, in addition to the configuration of the second embodiment. The use-status-parameter generation function 93 is an example of a use-status-parameter generation unit.

In the present modification, the correction function 81 corrects the necessity output from the necessity calculation function 76, based on a deterioration parameter received from the deterioration-parameter generation function 82 and a use status parameter received from the use-status-parameter generation function 93.

The use-status-parameter generation function 93 acquires a used amount of a structure. The used amount is a numerical value representing an amount of usage of a structure. For example, when the structure is a road, the used amount can be the number of vehicles having passed thereon in a period from a predetermined time point to the reference time. Further, when the structure is a railway track, the used amount can be the number of times trains have passed thereon in a period from a predetermined time point to the reference time.

Further, when the structure is a road, the possibility of deteriorating the structure is higher by a large-sized vehicle than by a small-sized vehicle. Therefore, when the structure is a road, points are allocated to each type of vehicles in such a manner to increase in order of a small-sized vehicle, a medium-sized vehicle, and a large-sized vehicle. In this case, the used amount can be a value obtained by accumulating the points of vehicles having passed thereon in a period from the predetermined time point to the reference time.

The use-status-parameter generation function 93 generates a use status parameter based on the used amount. Here, the use status parameter indicates the used amount of the structure. The correction function 81 corrects the used amount output from the necessity calculation function 76 based on the use status parameter. Specifically, the correction function 81 increases the necessity in a case where the used amount of the structure is large than in a case where the used amount of the structure is small.

It is assumed here that the necessity before correction is yₘ, the deterioration parameter is g_{d}, the use status parameter is gᵤ, and the necessity after correction is y. In this case, the correction function 81 corrects the necessity as expressed in the following equation (17).

y=yₘ×g_{d}×gᵤ (17)

When the correction function 81 corrects the necessity as expressed in the equation (17), the g_{d} is the same as in the equation (12). The use-status-parameter generation function 93 sets the gᵤ to 1 when there is very little used amount of the structure, and sets the gᵤ to a value larger than 1 when the used amount of the structure is large.

Further, the correction function 81 can correct the necessity as expressed in the following equation (18).

y=yₘ+g_{d}+gᵤ (18)

When the correction function 81 corrects the necessity as illustrated in the equation (18), the g_{d} is the same as in the equation (13). The use-status-parameter generation function 93 sets the gᵤ to 0 when there is very little used amount of the structure, and sets the gᵤ to a value larger than 0 when there is a large used amount of the structure.

In this manner, the deterioration management function 52 according to the present modification can increase the necessity as the used amount of the structure increases.

Further, the deterioration-degree aggregation function 83 weights each of the received deterioration degrees with the corresponding aggregate parameter to calculate a mean value of the weighted deterioration degrees. In the second embodiment, the aggregate parameter takes a larger value as the deterioration degree has higher reliability. Therefore, the deterioration-degree aggregation function 83 can output an aggregate deterioration degree having higher accuracy.

The deterioration management function 52 according to the present modification can have a configuration of not including the deterioration-degree aggregation function 83. Further, the deterioration management function 52 can have a configuration of not including the correction function 81, the deterioration-parameter generation function 82, and the use-status-parameter generation function 93. The deterioration management function 52 according to the present modification can also have a configuration of not including either the deterioration-parameter generation function 82 or the use-status-parameter generation function 93.

### Third Embodiment

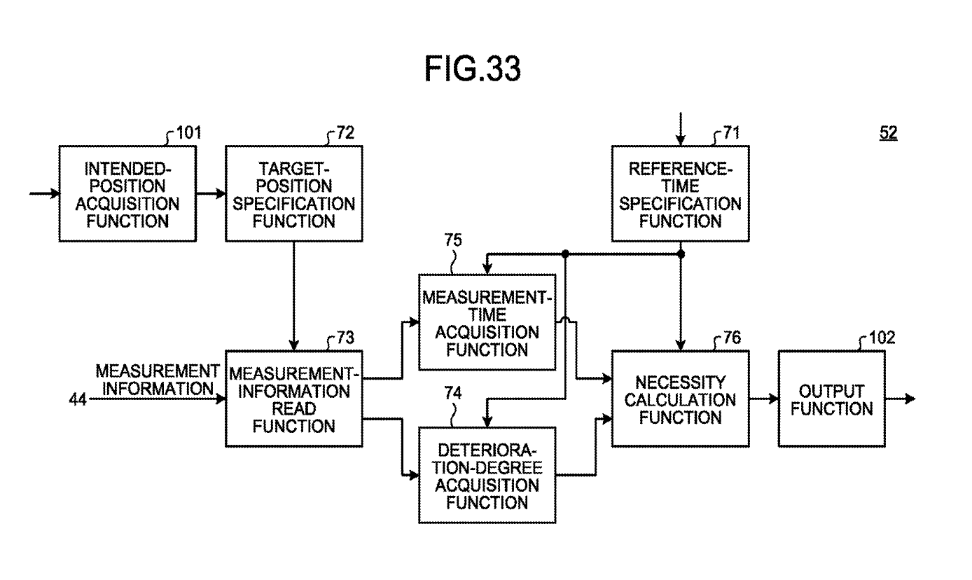

FIG. 33 is a diagram illustrating a configuration of the deterioration management function 52 according to a third embodiment. The mobile apparatus 20 according to the third embodiment measures the deterioration degree by imaging a structure such as a road while moving. The information processing apparatus 40 according to the third embodiment acquires one or more intended positions at which the mobile apparatus 20 intends to measure the deterioration degree, prior to the movement of the mobile apparatus 20. The information processing apparatus 40 calculates and outputs the necessity for each of the acquired one or more intended positions. Accordingly, the information processing apparatus 40 can cause the mobile apparatus 20 to determine the position to measure the deterioration degree among the respective intended positions. Therefore, the information processing apparatus 40 can cause the mobile apparatus 20 to efficiently measure the deterioration degree, while moving.

The deterioration management function 52 according to the third embodiment further includes an intended-position acquisition function 101 and an output function 102, in addition to the configuration of the first embodiment. The intended-position acquisition function 101 is an example of an intended-position acquisition unit. The output function 102 is an example of an output unit.

The intended-position acquisition function 101 acquires aggregation of one or more intended positions at which it is intended to perform measurement, for example, from the mobile apparatus 20. The intended-position acquisition function 101 can acquire a set of the intended positions from information input from a user, or acquire a set of the intended positions from information input from a device other than the mobile apparatus 20.

The target-position specification function 72 specifies a target position sequentially from the set of the intended positions. The measurement-information read function 73, the deterioration-degree acquisition function 74, the measurement-time acquisition function 75, and the necessity calculation function 76 perform the process with respect to the target position specified by the target-position specification function 72. The necessity calculation function 76 calculates the necessity with respect to each of the target positions.

The output function 102 outputs the necessity with respect to each intended position. For example, the output function 102 displays information representing the necessity at a portion corresponding to each intended position on a map, which is a guide for movement of the mobile apparatus 20.

In the first and second embodiments, the necessity calculation function 76 calculates the necessity based on the premise that there are a plurality of deterioration degrees measured at different measurement times with respect to the target position. However, in the third embodiment, the necessity calculation function 76 can output the necessity having a preset value, when the plurality of deterioration degrees measured at different measurement times are not present with respect to the target position. For example, when there is no deterioration degree or there is only one deterioration degree with respect to the target position, the necessity calculation function 76 can output the highest necessity. Further, when there is no deterioration degree with respect to the target position, the necessity calculation function 76 can decide that the aggregate deterioration degree is unknown.

Further, the necessity calculation function 76 can output the necessity based on the measurement time with respect to the target position at which there is only one deterioration degree. In this case, the necessity calculation function 76 can increase the necessity as the measurement time is farther away from the reference time (that is, as the deterioration degree is obtained by an older measurement). The necessity calculation function 76 can set the present deterioration degree directly as the aggregate deterioration degree with respect to the target position at which there is only one deterioration degree.

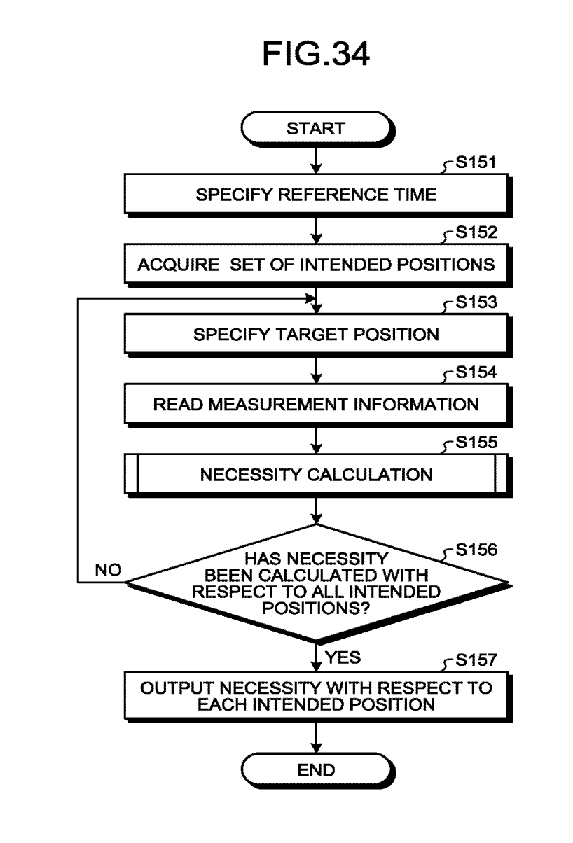

FIG. 34 is a flowchart illustrating a process flow of the deterioration management function 52 according to the third embodiment. The deterioration management function 52 according to the third embodiment performs the process according to the flowchart illustrated in FIG. 34.

First, the deterioration management function 52 specifies the reference time (S151). Next, the deterioration management function 52 acquires a set of the intended positions (S152).

Subsequently, the deterioration management function 52 specifies one target position from the set of the intended positions (S153). The deterioration management function 52 then reads the measurement information corresponding to the specified target position (S154).

The deterioration management function 52 calculates the necessity of additional measurement of the deterioration degree according to a preset calculation process based on the deterioration degrees measured at different measurement times (S155). When there is no deterioration degree or there is only one deterioration degree with respect to the target position, the deterioration management function 52 can output the necessity having a preset value. When there is only one deterioration degree with respect to the target position, the deterioration management function 52 can calculate the necessity according to a calculation process in which the necessity is increased as the elapsed time increases.

Subsequently, the deterioration management function 52 determines whether the necessity has been calculated with respect to all the intended positions (S156). When the necessity has not been calculated with respect to all the intended positions (NO at S156), the deterioration management function 52 returns the process to S153, to repeat the process with respect to the next target position. When the necessity has been calculated with respect to all the intended positions (YES at S156), the deterioration management function 52 advances the process to S157.

At S157, the output function 102 outputs the necessity with respect to each intended position. For example, the output function 102 displays information representing the necessity on a portion corresponding to the intended position on a map.

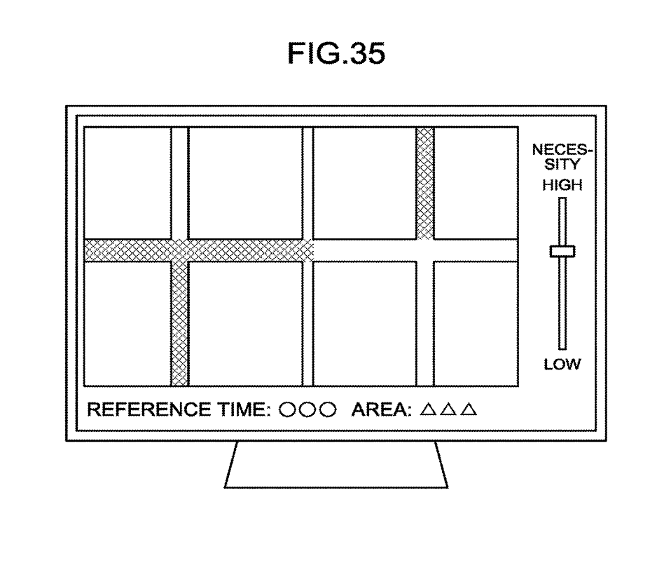

FIG. 35 is a diagram illustrating a first display example of the necessity by the output function 102. The output function 102 aggregates the necessity with respect to each intended position and displays the necessity at a corresponding position on a map. In this case, the output function 102 can display the necessity on the map, by distinguishing a position having the necessity equal to or higher than a threshold from a position having the necessity lower than the threshold.

For example, as illustrated in FIG. 35, when the structure is a road, the output function 102 can display a map in which a position having the necessity equal to or higher than the threshold is displayed in a predetermined color or by hatching. Further, the output function 102 can receive a threshold change operation by a user. Accordingly, the output function 102 can cause a user to confirm a change of the position having the necessity equal to or higher than the threshold, when the threshold is increased or decreased.

The output function 102 can display a map in which the position having the necessity equal to or higher than the threshold is added with a popup mark such as “require measurement”. Further, the output function 102 can list display IDs or section names representing a section to be measured additionally, instead of displaying a map.

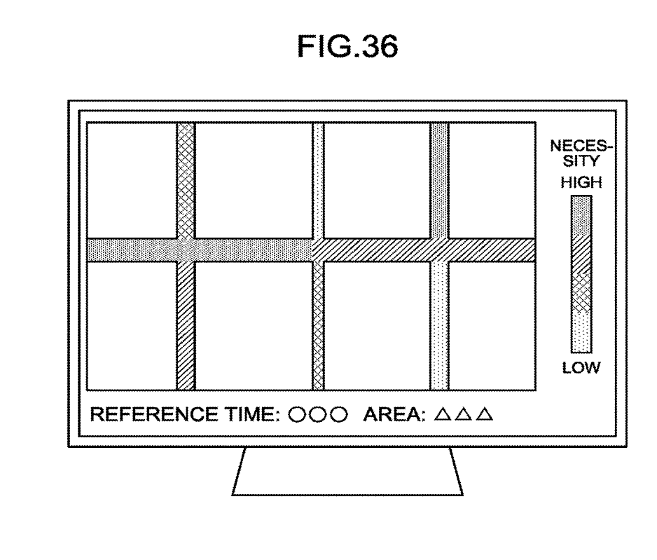

FIG. 36 is a diagram illustrating a second display example of the necessity by the output function 102. The output function 102 can divide the necessity into a plurality of levels and display a map differently colored or differently hatched for each level such as in a heat map. For example, the output function 102 can display a map in which a section having the highest necessity is colored in red, a section having the lowest necessity is colored in blue, and respective levels having the intermediate necessity are colored so as to gradually change from red to blue.

Further, the output function 102 can display a map added with a popup mark indicating the level of necessity in addition to the coloring or hatching as in a heat map. The output function 102 can list display IDs or section names representing the section to be measured additionally in a ranking format, instead of displaying the map. Further, the output function 102 can extract a predetermined number of positions (or sections) having higher-order necessity and display the positions (or sections) on a map or in a list.

As described above, the deterioration management system 10 according to the third embodiment can specify a position at which the deterioration degree is to be measured additionally from respective intended positions. Accordingly, the deterioration management system 10 can cause the mobile apparatus 20 to efficiently measure the deterioration degree, while moving.

### Modification of Third Embodiment

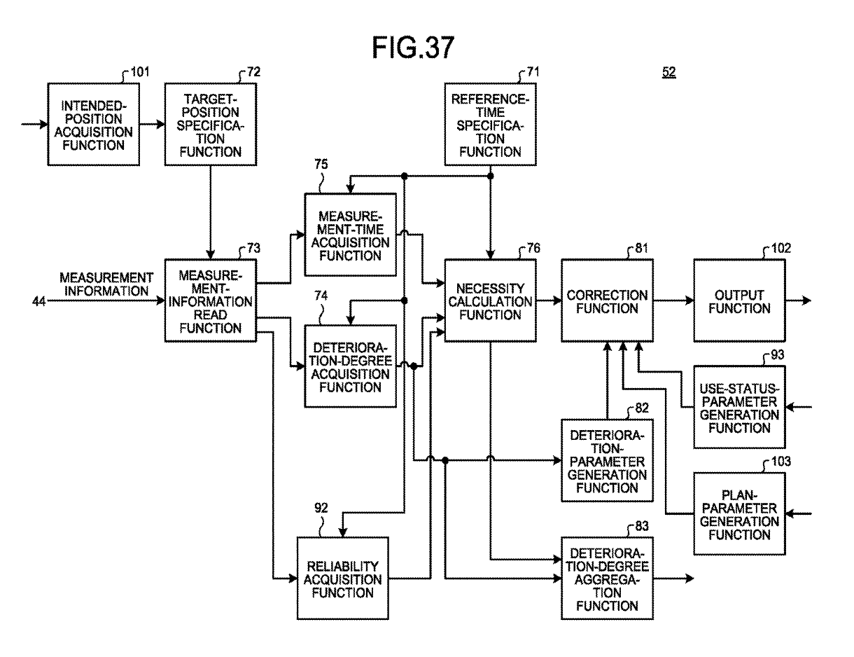

FIG. 37 is a diagram illustrating a configuration of the deterioration management function 52 according to a modification of the third embodiment. The deterioration management function 52 according to the modification of the third embodiment further includes the correction function 81, the deterioration-parameter generation function 82, the deterioration-degree aggregation function 83, the reliability acquisition function 92, the use-status-parameter generation function 93, and a plan-parameter generation function 103, in addition to the configuration of the third embodiment. The plan-parameter generation function 103 is an example of a plan-parameter generation unit.

In the present modification, the correction function 81 receives a deterioration parameter, a use status parameter, and a plan parameter. The correction function 81 corrects the necessity output from the necessity calculation function 76 based on the received parameters. The correction function 81 provides the corrected necessity to the output function 102.

The plan-parameter generation function 103 receives a measurement plan with respect to a target position. The measurement plan includes information indicating whether measurement of the deterioration degree is planned. Further, when measurement of the deterioration degree is planned with respect to the target position, the measurement plan can include a planned measurement time. The plan-parameter generation function 103 generates a plan parameter with respect to the target position based on the measurement plan.

The plan parameter indicates whether it is planned to measure the deterioration degree with respect to the target position. The plan parameter also represents a period from the reference time to the planned measurement time, when it is planned to perform measurement.

The correction function 81 decreases the necessity when it is planned to measure the deterioration degree with respect to the target position, based on the plan parameter. Further, the correction function 81 increases the necessity as the planned measurement time is farther away from the reference time, based on the plan parameter.

It is assumed here that the necessity before the correction is yₘ, the deterioration parameter is g_{d}, the use status parameter is gᵤ, the plan parameter is gₚ, and the necessity after the correction is y. In this case, the correction function 81 corrects the necessity as expressed in the following equation (19).

y=yₘ×g_{d}×gᵤ×gₚ (19)

When the correction function 81 corrects the necessity as expressed in the equation (19), the g_{d} and the gᵤ are the same as in the equation (17). The plan-parameter generation function 103 sets the gₚ to 1.0 when it is not planned to perform measurement. Further, the plan-parameter generation function 103 sets the gₚ to a predetermined value close to 0.0, when it is planned to perform measurement. Further, when it is planned to perform measurement, the plan-parameter generation function 103 can set the gₚ to a variable value that approaches to 0.0 and is from 0.0 to 1.0 inclusive as the planned measurement time approaches to the reference time.

Further, the correction function 81 can correct the necessity as expressed in the following equation (20).

y=yₘ+g_{d}+gᵤ+gₚ (20)

When the correction function 81 corrects the necessity as expressed in the equation (20), the g_{d} and the gᵤ are the same as in the equation (18). The plan-parameter generation function 103 sets the gₚ to 0.0 when it is not planned to perform measurement. Further, the plan-parameter generation function 103 sets the gₚ to a predetermined value smaller than 0.0 (a negative value), when it is planned to perform measurement. Further, when it is planned to perform measurement, the plan-parameter generation function 103 can set the gₚ to a variable value that is smaller than 0.0 and decreases as the planned measurement time approaches to the reference time.

In this manner, the deterioration management function 52 according to the present modification can decrease the necessity when it is planned to measure the deterioration degree in the future.

The deterioration management function 52 according to the present modification can have a configuration of not including the reliability acquisition function 92 or the deterioration-degree aggregation function 83. Further, the deterioration management function 52 according to the present modification can have a configuration of not including the correction function 81, the deterioration-parameter generation function 82, the use-status-parameter generation function 93, and the plan-parameter generation function 103. Further, the deterioration management function 52 according to the present modification can have a configuration of not including any one or two of the deterioration-parameter generation function 82, the use-status-parameter generation function 93, and the plan-parameter generation function 103.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory; and
processing circuitry configured to:
acquire a deterioration degree of a structure calculated based on an image including the structure captured by an imaging device;
acquire a measurement time, which is a date and time when the image being a basis of calculation of the deterioration degree has been captured; and
calculate necessity of additional measurement of the deterioration degree based on a plurality of the deterioration degrees measured at the measurement times different from each other.

2. The apparatus according to claim 1, wherein the processing circuitry calculates the necessity by a calculation process in which the necessity is increased as a change amount of the deterioration degree per unit time increases.

3. The apparatus according to claim 2, wherein the calculation process is a process of increasing the necessity as an elapsed time from the measurement time to a reference date and time of calculation of the necessity increases.

4. The apparatus according to claim 3, wherein
the processing circuitry
generates, for each of the deterioration degrees measured at different measurement times, a probability distribution in which an average is a value based on the deterioration degree and variance takes a value that decreases as an elapsed time from the measurement time to the reference date and time of calculation of the necessity decreases,
combines a plurality of the probability distributions for each of the deterioration degrees to generate a combined probability distribution, and
outputs, as the necessity, a value that increases as the variance in the combined probability distribution increases.

5. The apparatus according to claim 4, wherein the processing circuitry outputs, as an aggregate deterioration degree, an average of the combined probability distribution at the reference date and time of calculation of the necessity.

6. The apparatus according to claim 4, wherein the processing circuitry generates, for each of the deterioration degrees measured at different measurement times, the probability distribution in which the variance takes a value that decreases as reliability with respect to the deterioration degree increases.

7. The apparatus according to claim 3, wherein
the processing circuitry further configured to acquire reliability with respect to the deterioration degree, and
the calculation process is a process of increasing the necessity as the reliability decreases.

8. The apparatus according to claim 6, wherein the reliability increases as a luminance of the image approaches to a preset reference luminance.

9. The apparatus according to claim 6, wherein the reliability increases as a resolution of the structure in the image approaches to a reference resolution.

10. The apparatus according to claim 6, wherein the reliability increases as a moving speed of the imaging device at a time of capturing the image decreases.

11. The apparatus according to claim 2, wherein
the processing circuitry further configured to correct the necessity, and
the processing circuitry increases the necessity in a case where the deterioration degree has changed in a direction of worsening with time than a case where the deterioration degree has changed in a direction of improving with time.

12. The apparatus according to claim 2, wherein
the processing circuitry further configured to correct the necessity, and
the processing circuitry increases the necessity in a case where a used amount of the structure is large than a case where the used amount of the structure is small.

13. The apparatus according to claim 2, wherein
the processing circuitry further configured to correct the necessity, and
the processing circuitry decreases the necessity when it is planned to perform measurement.

14. The apparatus according to claim 1, wherein
the imaging device is mounted on a mobile apparatus to image the structure while moving,
the processing circuitry acquires a position at which the image has been captured and the deterioration degree, and
the processing circuitry calculates the necessity for each position.

15. The apparatus according to claim 14, wherein the processing circuitry calculates the necessity indicating whether to perform additional measurement for each position.

16. The apparatus according to claim 14, wherein
the processing circuitry further configured to acquire at least one intended position at which it is intended to perform measurement, and
the processing circuitry calculates the necessity with respect to each of the intended positions.

17. The apparatus according to claim 16, further comprising an output unit to display information representing the necessity at a portion corresponding to each of the intended positions on a map, the map being a guide for movement of the mobile apparatus.

18. The apparatus according to claim 14, wherein the processing circuitry outputs a predetermined necessity with respect to a position at which the deterioration degrees measured at different measurement times are not present.

19. An information processing method performed by an information processing apparatus, the method comprising:
acquiring a deterioration degree of a structure calculated based on an image including the structure captured by an imaging device;
acquiring a measurement time, which is a date and time when the image being a basis of calculation of the deterioration degree has been captured; and
calculating necessity of additional measurement of the deterioration degree based on a plurality of the deterioration degrees measured at the measurement times different from each other.

20. A computer program product comprising a non-transitory computer-readable medium containing a program executed by a computer, the program causing the computer to execute:
acquiring a deterioration degree of a structure calculated based on an image including the structure captured by an imaging device;
acquiring a measurement time, which is a date and time when the image being a basis of calculation of the deterioration degree has been captured; and
calculating necessity of additional measurement of the deterioration degree based on the deterioration degrees measured at the measurement times different from each other.
